(19) United States
(12) Patent Application Publication
(10) Pub. No.: US 2026/0228472 A1
(43) Pub. Date: Aug. 6, 2026

(54) SYSTEMS AND METHODS FOR ASYNCHRONOUS OPTICAL COMMUNICATIONS

(71) Applicant: OWiC Technologies Inc., Ithaca, NY (US)

(72) Inventors: Alejandro J. Cortese, Ithaca, NY (US); Alyosha Molnar, Ithaca, NY (US); Paul L. McEuen, Ithaca, NY (US); Kevin Sun, Ithaca, NY (US)

(73) Assignee: OWiC Technologies Inc., Ithaca, NY (US)

(21) Appl. No.: 19/565,401

(22) Filed: Mar. 12, 2026

Related U.S. Application Data
(63) Continuation of application No. PCT/US2024/045795, filed on Sep. 9, 2024.
(60) Provisional application No. 63/582,762, filed on Sep. 14, 2023.

(51) Int. Cl. G06K 7/14; G06K 19/06

(52) U.S. Cl. CPC G06K 7/1417; G06K 7/1413; G06K 19/06028; G06K 19/06037

(57) ABSTRACT

A system configured to provide information via an optical signal includes an optical tag circuit comprising an electric power source configured to generate an electric current for powering the optical tag circuit from incident light and a light emitter configured to emit the information as an encoded optical signal at an emission frequency. The system also includes an optical tag circuit reader including an image capture device configured to capture the encoded optical signal at a capture frequency without requiring synchronization of the capture frequency to the emission frequency and a processor configured to obtain the information from the encoded optical signal.

### CROSS-REFERENCE TO RELATED APPLICATIONS

This application is a continuation of International Patent Application No. PCT/US 2024/045795, filed Sep. 9, 2024, entitled “SYSTEMS AND METHODS FOR ASYNCHRONOUS OPTICAL COMMUNICATIONS,” which claims the benefit of and priority to U.S. Provisional Patent Application No. 63/582,762, filed Sep. 14, 2023, entitled “SYSTEMS AND METHODS FOR ASYNCHRONOUS OPTICAL COMMUNICATIONS” the entire disclosures of which are hereby incorporated by reference, for all purposes, as if fully set forth herein.

### BACKGROUND OF THE INVENTION

There is a growing interest and need for linking digital content and sensor information to the physical world. As examples, QR codes and data matrices using information encoded spatially are used in laboratories across the globe to link patient data to small vials, in grocery stores to link dietary information to packaged food and beverages, and in homes to launch applications from product packaging or installation instructions. The information extracted from these links is often read out with electronic devices equipped with a camera such as a smartphone or standalone electronic reader.

There is additionally growth in the Internet of Things (IOT) to extract sensor and identification information from physical objects such as temperature, humidity, or pressure and digitally link that information to objects. This is often accomplished with RF-powered or battery-powered electronic sensors or identification tags on objects that transmit information with RF signals that are received by an electronic device. Methods and devices for linking such digital content and sensor information to physical objects in increasingly smaller form factors are widely desired. This desire can be motivated by the size of the object being too small for current link devices or by aesthetic considerations where an object's appearance may be altered significantly by the presence of large link technology.

### SUMMARY OF THE INVENTION

The present disclosure relates to asynchronous, optical-signal communications, and more particularly asynchronous communications between an optical tag circuit configured for transmitting encoded information stored on an opto-electronic tag and a reader configured for retrieving and decoding the information.

In some embodiments, a system is configured to provide information via an optical signal. Information as used herein may refer to data, for example, metadata, facts, statistics, details, or any entity to be conveyed by or collected in the system. Information may be saved, stored, or relayed for transmission. For example, information may include data stored in a memory or provided by at least one sensor. The information may be transmitted through a light or optical signal. An optical signal may refer to an electromagnetic signal using any form of light to relay information. The optical signal may be manipulated or altered in time or space to transmit the information. For example, the optical signal may include variable wavelength, frequency, timing, or positioning. By varying or controlling one or more of these parameters, specific information can be represented and broadcast via an optical signal.

According to some embodiments, a system configured to provide information via an optical signal is provided. The system includes an optical tag circuit having an electric power source configured to generate an electric current for powering the optical tag circuit from incident light, and a light emitter configured to emit the information as an encoded optical signal at an emission frequency. The system includes an optical tag circuit reader, having an image capture device configured to capture the encoded optical signal at a capture frequency without requiring synchronization of the capture frequency to the emission frequency, and a processor configured to obtain the information from the encoded optical signal.

In some embodiments, an optical tag circuit is configured to provide information via an optical signal. A tag may refer to a piece of information or a keyword that represents data, including data on a tagged object. The tag, i.e., information may be stored or saved on an optical tag circuit for extraction or transmission. An optical tag circuit may refer to circuity that is at least partially powered by light, a circuit that emits light or an optical signal providing information, or a combination thereof. An optical tag circuit can be of varying size so as to fit on small or large objects. For example, a very small optical tag circuit may fit on an electrode sensor used to monitor heart rate while being able to provide data from the sensor.

Consistent with some embodiments, an area of an optical tag circuit measured as a first dimension X times a second dimension Y is less than 9 square millimeters. X and Y dimensions may refer to any outer dimensions of the optical tag circuit. Each dimension may represent a measurement in one direction, line, or plane and may refer to the length or width of the optical tag circuit. The length and width as used herein describe the outermost edges of the optical tag circuit. For example, if the outer edges of the optical tag circuit form a rectangular shape, the length would be the long edge, and the width would be the shorter edge. In a three-dimensional environment, the rectangle would also have a thickness. The thickness of the optical tag circuit may be less than its length or width. Consistent with some embodiments, one or more outer edges of the optical tag circuit is less than 3 millimeters. The thickness of the optical tag circuit may be less than 0.3 millimeters.

Consistent with some embodiments, a first optical tag circuit comprising a first dimension X and a second optical tag circuit comprising second dimension Y oriented such that the first optical tag circuit is adjacent to the second optical tag circuit and a combination of the first optical tag circuit and the second optical tag circuit comprises a combined dimension X+Y that is less than a minimum dimension. A pair of optical tag circuits placed adjacent to one another may refer to any edge of the first optical tag circuit abutting any edge of the second. For example, an alignment of two adjacent edges may result in perpendicular edges which combine with the dimension X+Y. Alternatively, the two circuits may be very close in proximity or perhaps overlapping. A minimum dimension may refer to the smallest dimension allowing two distinct optical tag circuits to be resolvable without magnification or assistance, and may be determined via reference to a unit pixel resolution of an image capture device. For example, a tag may not be resolvable as distinct from two tags adjacent to one another, independent of the image capture device being used, when the tag is sized less than or equal to 10×10 unit pixels as determined based on the unit pixel resolution of the image capture device.

An optical tag circuit of such a size may be difficult to manufacture, particularly when the goal is to transmit information using an optical signal. Producing the signal would require electrical components that may operate to provide a source of energy, a way to measure or relay measurements or data, timing circuitry, signaling circuitry, and other seemingly complex features.

In some embodiments, a power source is configured to transduce incident light to an electric current for powering the optical tag circuit. Power source and electric power source may be used interchangeably, herein. A power source may refer to any source of energy provided to the optical tag circuit. For example, a power source may include incident light, which may refer to any light of any wavelength from any source that is incident on a light sensor, detector, array, or any light absorbing electrical component. When light is absorbed by a light absorbing electrical component, energy from the light may be transduced to an electric current, which may refer to a flow of energy, particles, or charge in or around the optical tag circuit. For example, light from an environment surrounding the optical tag circuit may provide energy to the optical tag circuit, where it is transduced to an electric current that flows through the optical tag circuit to provide power to the optical tag circuit components.

Consistent with some embodiments, the electric power source comprises at least one photovoltaic cell. A photovoltaic cell may be an example of a light absorbing electrical component that may transduce light energy to electric energy in the form of an electric current or a voltage. The cells may include, for example, monocrystalline silicon, polycrystalline silicon, amorphous silicon, thin film, perovskite, organic, quantum dots, multijunction, concentration, N-type semiconductors, or P-type semiconductors.

Consistent with some embodiments, the incident light comprises a broad spectrum of wavelengths from one or more of ambient light, reflected light, sunlight, light reflected from the optical tag circuit, and light from a mobile device. A broad spectrum of wavelengths may refer to an assortment of wavelengths in a range that may be continuous or non-continuous. There is no restriction to any particular range of wavelengths. For example, incident light may include infrared or ultraviolet light from the sun, or visible light from a fluorescent bulb in a building. Ambient light may refer to any light from an environment surrounding the optical tag circuit. A mobile device may refer to any portable or movable device. The mobile device may, for example, include use of a torch or flashlight component that may provide the incident light.

Consistent with some embodiments, the electric power source is further configured to provide the electric current while receiving less than 10 microwatts per square millimeter of incident light, and although this may be very little light, consistent with a dimly lit environment, the optical tag circuit will be able to operate including transmitting information via an optical signal.

Consistent with some embodiments, the first photovoltaic cell stack is configured to provide a first voltage to the optical tag circuit, and a second photovoltaic cell stack configured to provide a second voltage higher than the first voltage to the light emitter. A photovoltaic cell stack may be a series of semiconductor materials stacked on top of one another, each of which is able to absorb light and transduce light energy to electricity in the form of a voltage or electric current. These semiconductor materials may include light absorbing layers, electrodes, or substrates, for example. One benefit of using a stack is to improve efficiency, including for example, the overall transduction of incident light energy. For example, each component of the stack may be able to absorb light of different wavelengths more effectively than the other components of the stack. As described herein, at least two photovoltaic cell stacks may be used, one of which is configured to provide a higher voltage to the optical tag circuit, as compared to the other. This may be useful, for example, if some components require a higher voltage and others a lower voltage. As used herein, higher and lower are used for relative comparison, and do not indicate or imply any absolute range.

Consistent with some embodiments, the electric power source comprises at least one power storage device configured to store electric power provided by one of the first photovoltaic cell stack and the second photovoltaic cell stack. Electric current generated by the power provided from the stacks may be stored in a storage device that is integrated with the optical tag circuit. Storing the electric power may refer to obtaining the electric energy via a current to be storage in a storage component, which may include a battery or a capacitor, for example. The storage component may then enable a continuous or delayed provision of energy to the optical tag circuit. For example, a photovoltaic cell stack may transduce light energy to electric current which then flows to a storage component, where the current is stored as charge or electric energy.

In some embodiments, the optical tag circuit comprises a light emitter configured to emit the information as an encoded optical signal. A light emitter may refer to any electric component that is able to use electric energy to emit light. For example, a light emitter may include a light-emitting diode (LED), a laser, a laser diode, or a broadband or narrowband lamp. The light emitter may include a filter used to restrict or control the wavelength of light emitted, for example. An encoded optical signal may refer to an optical signal that contains spatially encoded or temporally encoded information, for example. Spatially encoded information may occur when, for example, taking a single image of the information and extracting the information, as may be the case with the use of QR codes and barcodes. Alternatively, temporally encoded information may occur, for example, when information is encoded over a period of time and to extract the information, a signal must be captured over multiple data points over time, such as may be the case with a radio signal, streamed information, or a light flashing morse code. To produce an encoded optical signal, information that is present in a form consistent with the use of computers or computer memory, such as stored data, can be converted to an optical signal that may include temporal encoding, for example.

In some embodiments, the optical tag circuit comprises a light emitter configured to emit an optical signal in response to an electrical pulse. An electrical pulse may have an amplitude, shape, and width, and may refer to a bolus, spike, peak, or sudden change of energy or current in the optical tag circuit. Such a pulse may be used to initiate a light emitter to emit light. For example, an electrical pulse may be generated elsewhere in the optical tag circuit, and when electric current reaches the light emitter, the emitter emits light.

In some embodiments, the optical tag circuit comprises a light emitter configured to emit the information as an encoded optical signal at an emission frequency. The encoded optical signal may be produced by a controlled, timed electrical pulse. The timing of the pulse may relate directly to an emission frequency. An emission frequency may refer to the frequency of repeated pulses or emission of the optical signal as pulses over time. The emission frequency may be constant or variable depending on the information encoded in the optical signal. The emission frequency may be thought of as the inverse of the time between consecutive electrical pulses or emissions from the light emitter. For example, the emission frequency may be slow then suddenly speed up, or vice versa, to represent different data over time.

Consistent with some embodiments, the power source comprises a first plurality of photovoltaic cells connected in series and configured to operate at a first voltage to provide electric current to the light emitter during an electrical pulse, the first stack. A second plurality of photovoltaic cells is connected in parallel and configured to operate at a second voltage lower than the first voltage to provide electric current to the encoder, the second stack. A first voltage may be obtained by using the first stack in a series orientation, which keeps the voltage relatively higher, as compared to a second voltage, which may be obtained by using the second stack in a parallel orientation. A series orientation of the photovoltaic cells may result in an additive effect of the voltages for each semiconductor component or cell in the first stack. The parallel orientation of the photovoltaic cells may result in the output of the stack having the same voltage as a single cell within the second stack, and the output current may be additive from the components or cells. There are various reasons why these orientations may be preferred. For example, the light emitter may require a relatively higher voltage than the encoder and related electronics, for example. In this situation, the light emitter may be best served to be provided energy from a series-configured stack of cells, while the encoder and related electronics may be better served from a parallel-configuration of the stack.

Consistent with some embodiments, an anti-reflective layer is applied on at least a surface of the optical tag circuit exposed to ambient light. The anti-reflective layer comprises a void at a region of the optical tag circuit where the light emitter is located. A void may refer to an area where the anti-reflective layer is not located, an area where, for example, a different layer or material is located, or an area where the anti-reflective layer is applied but does not affect a desired transmission of light. An anti-reflective layer may be, for example, a coating, film, layer, glazing, sheet, material, or substrate applied to reduce the reflection of light. Reflection of light could be, for example, Fresnel reflections. Some examples of anti-reflective layers include index-matching, single-interference, multi-layer interference, absorbing, moth eye, and circular polarizer. Furthermore, the layers may include Rayleigh's film, interference coatings, and textured coatings, for example. The anti-reflective layer may refer to a thin layer of dielectric material or optical coating with properties chosen to reduce reflection of light. Some of the properties may include the refractive index, thickness, absorbance, and dispersion. For example, the absorbance of the layer may be higher than the underlying surface, thereby preventing reflection of light. This absorbance-enhancing layer may allow light to be transmitted through the void, but not elsewhere. In another example, an anti-reflective layer may be chosen to provide a refractive index step-up from air to the optical tag circuit to reduce drastic changes that light experiences when traversing the boundary between mediums. In yet another example, the coating may be chosen to have a thickness of the wavelength of light desired to pass through, or harmonics of that wavelength, as may be the case for a V coat. For example, an anti-reflective layer may behave like a V coat and have a thickness selected to reduce reflection for a narrow band of light wavelengths, as may be used for a laser. In yet another example, the anti-reflective coating may comprise a thin layer (e.g., between 1 and 1000 microns) that absorbs light such as, for example, evaporated carbon. In yet another example, the anti-reflective coating may be selectively applied to the most reflective portions of the tag such as, but not limited to, the metal electrical interconnects.

Consistent with some embodiments, the power source powering the optical tag circuit comprises a plurality of photovoltaic elements, and the optical tag circuit comprises an absorption layer configured to increase absorption of the ambient light into the plurality of photovoltaic elements. The absorption layer comprises a second void in a region of the optical tag circuit where the light emitter is located. As described elsewhere herein, an absorption layer may behave as an anti-reflective layer by preventing light from reflecting, and instead allowing the light to be absorbed into the surface of the absorption layer on the optical tag circuit. For example, the light could be absorbed and the energy transmitted to the photovoltaic elements, which may refer to cells or stacks. The absorption layer may also refer to a layer which prevents the light from reflecting, and transmits the light to the photovoltaic elements. For example, a Rayleigh's film may be used to provide a step-up or step-down effect by selecting an absorption layer with an index of refraction approximately the mean between the indices of refraction of the entering and exiting mediums. Furthermore, in this example, if air is the entering medium with an index of refraction of n1=1, and a photovoltaic cell is the exiting medium with an index of refraction of n2=1.9, then an absorption layer may be selected with an index of refraction of approximately n3=1.45. By providing a void over the light emitter, the emitted light may not be affected. For example, an absorption layer may be applied everywhere on the optical tag circuit except for the location of the light emitter, which emits light efficiently already, which may enhance contrast between light from the emitter and areas adjacent to the where the light is emitted.

Consistent with some embodiments, the optical signal is comprised of a wavelength of light, and the anti-reflective layer is configured to increase absorption of the ambient light by the plurality of photovoltaic elements. The anti-reflective layer exhibits optical transparency at the wavelength. A wavelength as used herein may refer to a precise numerical wavelength of light or a narrowband range about a specific wavelength. For example, referring to wavelength as 700 nanometers would also include a range around 700 nanometers, for example, 700±5 nanometers or some other range around the stated wavelength. Optical transparency may refer to the property of a material that allows light to pass through the material without significant absorption, scattering, or reflection. The light emitter may have a narrow range of wavelengths output, as may be the case for a laser. An anti-reflective layer may be applied across the entire surface of the tag, including the light emitter, but the layer may have optical transparency at the wavelength at which the light emitter emits light.

Consistent with some embodiments, the optical signal comprises at least one wavelength of light, including at least one wavelength that overlaps with at least one wavelength of the incident light. The optical signal may occur in an environment containing a broad range of light from various sources. It is conceivable that the light emitter may emit an optical signal at a wavelength of light that is already present in the environment around the tag, including incident light. The optical signal can still transmit effectively in this scenario. Furthermore, the function of utility of the optical tag circuit and optical signal may not be affected by this overlap of wavelengths.

Consistent with some embodiments, the electric power source is further configured to accumulate electric energy transduced from the incident light and release the accumulated electric energy as a pulse configured to drive the light emitter. Accumulated electric energy may refer to collecting or storing the energy until it is ready to be released. The pulse may be consistent with the description of the term elsewhere herein. A pulse configured to drive the light emitter may refer to an amount of energy released rapidly to cause the light emitter to emit light during the pulse. For example, an LED may be on standby until it receives a sudden pulse which provides the energy it needs to emit light, then when the pulse ends, the LED ceases to emit light.

Consistent with some embodiments, a comparison module is configured to compare an available electric current of the power source to a predetermined current threshold of the light emitter. The predetermined current threshold corresponds to a minimum current for causing light emission at a desired intensity from the light emitter. A comparison module may be a part of the optical tag circuit that is used to perform a comparison of at least two voltage or current inputs. A comparison module may include, for example, an inverting or non-inverting comparison circuit operated by a differential voltage, rail-to-rail comparators, or an op-amp comparator. A predetermined current threshold may be a value that was established or decided in advance, or a property of the light emitter that may refer to a minimum current for the light emitter to allow it to emit light. A desired intensity may be any amount of light that is desired to be emitted in accordance with some basis, such as the brightness of the surroundings. For example, by comparing the available electric current from the power source to this predetermined current threshold, the comparison module may allow electric current to flow to the light emitter and cause it to emit light at a level brighter than the incident light on average. Consistent with some embodiments, the comparison module is further configured to implement a bias voltage when performing the comparing. A bias voltage may refer to an amount of voltage to offset from a baseline voltage to perform a desired operation. For example, a baseline voltage may be the power source voltage and a bias voltage may provide an offset from this voltage for comparison, thereby altering the point of comparison for the predetermined current threshold.

Consistent with some embodiments, the light emitter is configured to emit light when the incident light comprises an intensity less than milliwatts per square millimeter. The brightness of the emitted light can increase or decrease depending on the incident light. Furthermore, the storage of electric energy can enable sufficiently bright pulses of light even when the brightness of incident light is low on average. For example, in a dimly lit environment, the light emitter does not necessarily need to emit bright pulses, but simply pulses bright enough to be observed in the environment. Consistent with some embodiments, the optical tag circuit is configured to automatically vary an intensity of the optical signal based on an intensity of incident light. The optical tag circuit may be able to determine the brightness of incident light and increase the brightness of the optical signal pulses accordingly. Alternatively, the optical tag circuit may reduce the intensity of pulses if the incident light decreases. For example, the optical tag circuit may use photovoltaics powering the optical tag circuit and light emitter such that when the transduced electric current decreases, the current available for pulses decreases.

Consistent with some embodiments, the light emitter comprises one of a vertical-cavity surface-emitting laser (VCSEL), a micro light-emitting diode (microLED), and a resonant-cavity light-emitting diode (RCLED). A VCSEL may be a type of laser diode with a laser resonator, or a semiconductor laser diode with a laser emitted orthogonally from the surface of the VCSEL. Traditionally a VCSEL is not compact, but as used herein, the VCSEL may be sufficiently small so as to fit on the optical tag circuit. A microLED may be an LED that is made smaller than 100 micrometers. An RCLED may be a small light emitter that uses compound semiconductors and provides a high coupling efficiency and a fast response time.

Consistent with some embodiments, the VCSEL is configured to emit light in a conical emission profile, for example, at 10 degrees from normal. Conical emission may refer to a conical shape of emitted light in space and time, or circular rings of light that arise from nonlinear optical propagation of a laser. An angle or degree of conical emission may be related to wavelength or diffraction. Consistent with some other embodiments, the VCSEL is configured to emit light in a scattered pattern. A scattered pattern may refer to a direction of light that is randomized or semi-randomized. Alternatively, the scattered pattern may refer to a pattern that is controlled, such as a forward scattering. The scattered pattern may be generated by a material on the VCSEL or by the VCSEL itself. For example, light from the laser may be passed through a scattering material (e.g., a diffraction grating) that causes the light to scatter outward. Consistent with some other embodiments, the VCSEL is configured to emit light in a wide emission area. A wide emission area may refer to a wide angle of emissions or a wide area toward which light is to be emitted. The term “wide” as used with reference to an angle of light emission is intended to mean an angle greater than the conical pattern of a standard VCSEL. Therefore, taking an example VCSEL having a conical emission at 10 degrees from normal, a wide angle of emissions would encompass any light emitter having emissions greater than about 15 degrees from normal (a fifty percent increase).

Consistent with some embodiments, a configuration memory stores one or more of predefined brightness information and predefined emission frequency of the light emitter. Configuration memory may refer to any memory used to provide fundamental or operational information or data for a device or system. Configuration memory may, for example, comprise hexadecimal files stored in a boot block or memory block. For example, configuration memory may include information about previous operation and predefined brightness information. Predefined brightness information may, for example, refer to previously determined brightness of incident light, or it may refer to how the optical tag circuit operated in different incident light brightness conditions.

In some embodiments, an encoder is further configured to broadcast an optical signal via the light emitter without reception of external frequency data prior to the broadcast based on a predetermined current threshold of the power source. Encoding the information may refer to the process of transforming, representing, or altering the information for storage or transmission. Providing the encoded information as an electrical pulse may refer to the optical tag circuit interpreting the information and determining a series of pulses to represent the information for transmission. For example, a state machine could be used to determine the sequence of pulses corresponding to the information. External frequency data may refer to a frame rate, detector rate, or any exogenous source of information about frequencies or rates not inherent to the tag itself. This suggests that the optical tag circuit may operate continuously and independently of any external inputs, for example. Instead, the optical tag circuit will continue operating as long as the electric current from the power source continues to reach at least the predetermined current threshold that allows the light emitter to emit light and transmit the optical signal.

Consistent with some embodiments, an integrated circuit is configured to encode the information and provide timing and power pulses. An integrated circuit may be a set of electronic circuits or components, including, but not limited to, resistors, transistors, diodes, op amps, voltage sources, current sources, microprocessors, and capacitors, connected on at least one semiconductor material. The integrated circuit may be configured to operate the entirety of the optical tag circuit's operations, including providing timed pulses and power to drive the light emitter. The timing of pulses may be controlled by timing circuitry in the integrated circuit and may be used to encode information into optical signals which are emitted by the light emitted based on the power provided by the electrical pulses.

Consistent with some embodiments, a clock generation circuit is configured to provide a steady bit rate to provide the information. The clock generation circuit may be an electronic component operating as an oscillator with a precise timing used as a clock signal for synchronizing or coordinating the optical tag circuit 's operations. The clock signal may be used to regulate the timing of the electrical pulses in a precise way that allows for encoding the optical signal. A steady bit rate may refer to a consistent or predictable rate at which information bits are encoded or transferred.

Consistent with some embodiments, the electric power source is configured to release the electric current over time to generate the encoded optical signal based on a threshold current demand. A threshold current demand may refer to the predetermined threshold current that is required to enable the light emitter to emit light, consistent with the description provided elsewhere herein. For example, for a commercially available VCSEL as of the priority date of the present application, a threshold current may range between about 250 and 450 microamps, for example, 300 microamps. The electric power source may provide the electric current used to generate the optical signal over time as pulses, while continuously receiving input power from a source of energy, including, for example, incident light.

Consistent with some embodiments, the encoder is configured to encode the information in a series of consecutive sets of electrical pulses, each set of electrical pulses being comprised of a plurality of electrical pulses. Consecutive sets of electrical pulses may refer to a prescribed or predefined sequence of pulses provided in sets. Each set may, for example, corresponding to pieces or bits of information or data and the characteristics of the plurality of electrical pulses may allow for an encoding of the information in an optical signal. The pulses or sets may be spaced out in time with a variable time between the pulses. This variable time between pulses may represent, for example, a varying emission frequency, consistent with the term described elsewhere herein.

Consistent with some embodiments, the electric power source is configured to provide the pulse for a pulse duration, the pulse duration being approximately 10000 times less than a bit period to provide the information. A pulse duration may refer to the time that a pulse occurs, including, for example, the time duration from start to termination of the pulse. In some cases, the pulse duration may include a time immediately before or after the pulse, or a time duration that excludes a rise time or fall time of the pulse. A bit period may refer to the time duration required to encode, transmit, or provide the information. For example, a bit period may represent a set of pulses inclusive of the time duration occurring between the pulses. The bit period may include multiple pulses corresponding to information to be broadcast.

Consistent with some embodiments, a number of photons emitted by the light emitter during the bit period is greater than 1% of the photons in the incident light during the bit period. During the bit period, at least one pulse will occur with a significant amount of time where no pulse occurs. Conversely, incident light during the bit period may continuously be received by the optical tag circuit (e.g., via photovoltaic cells). The light emitter may emit light corresponding to more than 1% of the incident light. For example, sunlight may provide a continuous stream of power for the light emitter, and the light pulses during the bit period may take the energy from that sunlight and emit back more than 1% of the incident light.

Consistent with some embodiments, an encoder is configured to generate the encoded optical signal, a pulse generator is configured to trigger the pulse, and a plurality of semiconductor optoelectronics are configured to transduce the incident light to electric energy. A pulse generator may be an electronic component used to generate an electrical or signal pulse when triggered. The trigger may refer to an internal timing signal such as a clock signal, or a signal that may relate to external sources such as a signal indicating power provided by incident light. Semiconductor optoelectronics may be electronic devices that can absorb and transduce incident light and may refer to photovoltaic elements, for example.

Consistent with some embodiments, the optical tag circuit is configured to receive data from one or more sensors associated with an object and store the data as the information in a memory configured to be read by the encoder. A sensor may refer to an electronic device that detects or measures information or input from a physical environment. A sensor may detect, for example, light, heat, motion, moisture, pressure, sound, vibration, or any other type of environment stimulus. A sensor may obtain and provide data to be stored in memory, which may include onboard memory within an integrated circuit. The encoder may read the memory to obtain the data to be encoded in an optical signal, for example.

Consistent with some embodiments, the encoded optical signal comprises a binary encoding such that a 1 corresponds to a state when light is emitted by the light emitter and 0 corresponds to the state when there is no light emission by the light emitter, and 0s occur in groups of 2*N, wherein N is an integer. A binary encoding may refer to an encoding in which only 0 or 1 is used to represent information. As used herein, binary encoding may use a 1 to correspond with a pulse and a 0 to correspond with a time where no pulse is used or a pulse is to be skipped, for example. The value 0 may occur in groups or sequences with an even number of occurrences. This sequencing may allow for a predictable encoding of the optical signal, for example. Consistent with some embodiments, the encoded optical signal further comprises a finite integer limit for a number of zeros repeated in a sequence. A finite integer limit may refer to an integer value that restricts the number of zeroes that may occur in a sequence. A sequence may refer to a plurality occurring in a successive or consecutive order. A sequence of zeroes may be a group, order, series, chain, or pattern of zeroes. The number of zeroes in the sequence, may, for example, relate to the encoded information. Similarly, the timing and sequencing of ones either alone, or in combination with zeroes or other ones, may help relate to the encoded information. For example, the finite integer limit may be three zeroes, and a gap of time with no zero, or even a one, may occur following the three zeroes. Furthermore, the gaps of time between ones or zeroes may also relate to the encoded information.

Consistent with some embodiments, the encoder is configured to encode the information using a bit map corresponding to a variable pulse frequency associated with a plurality of the electrical pulses. A bit map may refer to mapping of information by taking the input information, translating or transforming the information to one or more bit symbols, and outputting the one or more bit symbols. Bit symbols may refer to a set or sequence comprising binary values. For example, binary values may include 0 or 1, and bit symbols may include 010, 0110, or 1111, among others. To convert, translate, or transform the information with high fidelity, the bit map may utilize a unique mapping of the information to bit symbols. A unique mapping should yield the same or consistent output for a given input. A unique mapping may be significant to accurately relay information outside the optical tag circuit. Alternatively, a non-unique mapping may occur, wherein multiple distinct outputs would be yielded for a given input. A variable pulse frequency may refer to a variation in the time between consecutive pulses from a plurality of the electrical pulses. The variable pulse frequency may be well-controlled by the timing circuitry in the optical tag circuit to relay information (i.e., the tag) with high fidelity. In some cases, the variable pulse frequency may not be exactly what is predicted for high accuracy of information exchange. For example, the power source may not be able to provide enough energy to produce an electrical pulse at every desired moment. Nonetheless, the optical tag circuit may still be able to relay the information, due at least in part to the bit map.

In some embodiments, a reader is configured to determine information via an optical signal. A reader may refer to any device used to obtain, scan, or capture and process the optical signal. The reader should be able to interpret, determine, or extract the information from the optical signal. The information may be determined, for example, by decoding the optical signal using the bit map, as described elsewhere herein. By using a predetermined encoding of the information, the reader may be trained, informed, or programmed in some way so as to allow the reader to determine the information.

In some embodiments, an image capture device is configured to capture the encoded optical signal at a capture frequency without requiring synchronization of the capture frequency to the emission frequency. An image capture device may refer to any device capable of obtaining or capturing an image. The image capture device may be the reader or a component of the reader. The image capture device may include, for example, a camera, a charge-coupled device (CCD) scanner, a complementary metal-oxide semiconductor (CMOS) array, a screen shot, a film to digital converter, or a photodiode array. A capture frequency may be a rate at which light is recording by the image capture device and read out digitally. The capture frequency may be fixed or variable. The capture frequency may include, for example, a detector frame rate, a camera frame rate, or a frequency at which an optical signal is captured. Synchronization is not required between the capture frequency and the emission frequency. Consistent with some embodiments, the capture frequency is different from the emission frequency. In some embodiments, the capture frequency and the emission frequency may be asynchronous, consistent with the definition of the term provided elsewhere herein. Furthermore, in some embodiments, the reader and camera system may be asynchronous. The reader and camera do not necessarily need to be in direct communication to perform a transmission of information.

Consistent with some embodiments, the information comprises at least two distinct features separated by a predetermined number of bit periods to estimate a ratio of the emission frequency to the capture frequency. Distinct features may refer to at least a pair of components before, during, or after non-distinct data or information. The distinct features may be represented by the bit symbols, and may include, for example, a preamble, a header, and a trailer of a data packet. The non-distinct data or information may include the payload of the data packet. The distinct features may be identifiable or separable from the non-distinct data or information. To help identify the distinct features, they may be separated by a predetermined number of bit periods. For example, one distinct feature may be followed by three bit periods, which are then followed by the second distinct feature. In this example, the reader may expect to look for two distinct features separated by the 64 periods. From this, an estimate of a ratio of the emission frequency to the capture frequency can be determined. Consistent with some embodiments, a ratio of the rate of information obtained in bits per second to the capture frequency in frames per second is less than 0.1. Bits per second may refer to a rate that information is broadcast. The rate of information output in bits per second from the optical tag circuit may be less than 10% of the capture frequency in Hertz of the image capture device. For example, the capture frequency may be fast enough to capture every pulse that may be emitted by the light emitter.

Consistent with some embodiments, the optical tag circuit is configured to generate a plurality of pulses to cause the light emitter to emit light in an information transmission period. A first duration between each pulse of the plurality of pulses within an information period is greater than a second duration corresponding to a readout time of the image capture device and less than 1/2 of the information transmission period. An information transmission period may refer to the time taken to transmit the information from the optical tag circuit to the reader. The period may also include the time used to encode the information and the time used to interpret the information by the reader. A readout time may refer to the time a camera takes to read the analog sensor values and digitize them, for example. The first duration between consecutive pulses may be less than the information transmission period inclusive of a readout time to ensure that the information is able to be received by the reader.

In some embodiments, an encoder is configured to encode the information and provide the encoded information as an electrical pulse to the light emitter. A first dimension, X, approximated to an integer n, and a second dimension, Y, approximated to an integer m, of the optical tag circuit are configured such that for a given unit pixel resolution, d, a first area defined by X*Y is less than a second area defined by (n*d)*(m*d), and an amount of information encoded by the encoder is greater than (n*d)*(m*d) as measured in bits. Encoding the information may refer to the process of transforming, representing, or altering the information for storage or transmission. Providing the encoded information as an electrical pulse may refer to the optical tag circuit interpreting the information and determining a series of pulses to represent the information for transmission. For example, a state machine could be used to determine the sequence of pulses corresponding to the information. A unit pixel may correspond with the pixel resolution of the image sensor of a camera, the fundamental optical limits of the optical system used for light collection in a camera, or other aberrations. A unit pixel may be a single pixel in the output image, or a collection of multiple pixels in the output image. The unit pixel resolution may correspond with the smallest resolvable area, and may be d*d, for example. The optical tag circuit may be able to transmit more information than is expected for its size. For example, the timing of the optical signal pulses may allow for encoding of information in time and therefore not require encoding in space, as may be the case for a QR or a barcode.

In some embodiments, an image capture device has a fixed unit pixel resolution, wherein one or more outer dimensions of the optical tag circuit are smaller than the fixed unit pixel resolution. The outer dimensions of the optical tag circuit are consistent with the description elsewhere herein. The outer dimensions may refer to the outermost edges of the optical tag circuit. For example, fixed unit pixel resolution may be d*d, and the optical tag circuit may have outer dimensions N*N, wherein N is less than d. This may suggest that the optical tag circuit can be extremely small so as to be smaller than a camera resolution, and the light emitter is even smaller than this. Nonetheless, the optical signal may be received by a single or multiple pixels to relay the information.

In some embodiments, the image capture device is configured to capture an encoded optical signal broadcast from an optical tag circuit without transmitting frequency data to the optical tag circuit prior to the capture of the encoded optical signal. The image capture device can receive information contained in the encoded optical signal without having relayed any information to the optical tag circuit. For example, the optical tag circuit will continue to provide information via an optical signal even without receiving any frequency data, including the capture frequency.

Consistent with some embodiments, no handshake occurs between the optical tag circuit reader and the optical tag circuit prior to and during capture of the encoded optical signal. A handshake may refer to any signal between two or more devices to facilitate communication between the two or more devices. Handshaking may occur, for example, when two computers exchange signals to establish a communication link. No handshaking may mean that the two or more devices are not directly synchronized or coordinated, for example. Indeed, the reader and camera system does not require synchronization to function, and so no handshaking may occur prior to transmission of information.

In some embodiments, a processor is configured to determine the information from the encoded optical signal. Consistent with disclosed embodiments, a processor may constitute any physical device or group of devices having electric circuitry that performs a logic operation on an input or inputs. For example, the at least one processor may include one or more integrated circuits (IC), including application-specific integrated circuits (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated into a single circuit. When more than one processor is used, the processors may be configured to operate independently or collaboratively and may be co-located or located remotely from each other. The processors may be coupled electrically, magnetically, optically, acoustically, mechanically or by other means that permit them to interact. The processor may be configured to interpret or decode information from the encoded optical signal, for example.

In some other embodiments, a processor is configured to determine a decoding scheme based on the encoded optical signal. A decoding scheme may refer to any method or program to deconstruct and reconstruct, interpret, translate, or transform an encoded optical signal. For example, the encoded optical signal may contain information that informs the processor on which decoding scheme to use or how to perform the decoding. In some other embodiments, a processor is configured to decode the encoded optical signal based on the decoding scheme to obtain the information. For example, decoding the encoded optical signal may involve using predetermined data regarding the bit symbols or bit mapping, based on a variable emission frequency, to reconstruct the original information from the optical tag circuit. Consistent with some embodiments, the processor is further configured to decode the optical signal using a decoding scheme to translate information from a ratio of the variable frequency of pulses corresponding to the optical signal to a frame rate frequency of the image capture device. For example, a bit mapping using the variable frequency of pulses as an input may provide an encoded optical signal in the form of bit symbols which are then decoded by the decoding scheme, and the information extracted by the reader.

Consistent with some embodiments, the processor is further configured to decode the information in the optical signal using a bit map corresponding to a variable pulse frequency associated with a plurality of pulses of the optical signal. The bit map may provide a reliable means to transmit the information with high fidelity, as described elsewhere herein. Consistent with some embodiments, the processor is further configured to decode the optical signal using a decoding scheme to provide the information for a plurality of ratios of the emission frequency to the capture frequency. For example, the decoding scheme may use various ratios to identify or distinguish information.

Consistent with some embodiments, the reader is a mobile device, and the image capture device comprises a camera mounted on the mobile device. A mobile device is any handheld, portable or moveable device. As described herein, the mobile device may comprise a screen, display, camera, detector, processor, and any other component used to operate as a reader. Consistent with some embodiments, the mobile device is a smartphone.

Consistent with some embodiments, the image capture device is configured to capture one or more images of an object on which the optical tag circuit is mounted, and wherein the processor is configured to identify visual characteristics of the object. The image capture device may obtain images of the optical tag circuit and the object to which the optical tag circuit is affixed. For example, the image capture device may be a smartphone camera that can take a photograph. Visual characteristics of the object may refer to any features, shapes, sizes, dimensions, colors, qualities, orientations, structure, or anything of note regarding the physical properties of the object. Consistent with some embodiments, compare the visual characteristics to the information. The information may be related to some features present in the identified visual characteristics, for example. It is conceivable that artificial intelligence or machine learning could be used to make predictions related to the information or the visual characteristics, or a combination thereof.

Consistent with some embodiments, at least some of the incident light originates from the reader. The reader may comprise a component that can emit light. For example, a smartphone comprises an LED or other light source configured to act as a flash and/or flashlight. In some situations, the reader may have a dedicated light source used to illuminate and provide power to the optical tag circuit. This may be desirable to produce an on-demand transmission of information from the optical tag circuit, for example.

Consistent with some embodiments, the optical tag circuit is further configured to increase a brightness of light from the light emitter over a plurality of orders of magnitude of an intensity of the incident light such that the reader is able to determine the information. Orders of magnitude of an intensity of the incident light may refer to multiples of 10, presenting a broad range over which the light emitter can be adapted based on the incident light brightness. This may be important, for example, if the incident light is unpredictable or variable. For example, in a dim environment, the light emitter does not need to emit bright light to transmit the optical signal, but in a bright environment, the light emitter may need to emit bright light to have a signal to noise high enough to transmit the information from the optical tag circuit.

Consistent with some embodiments, the optical tag circuit is configured to operate with no downlink from the reader. A downlink may refer to a signal provided from communication equipment towards a data terminal, station, or receiver. As described herein, a downlink may refer to a signal that would be provided by a reader. No such downlink may occur herein, as the optical tag circuit may operate continuously without any input from the reader. Consistent with some embodiments, the optical tag circuit reader and the optical tag circuit communicate without handshaking. The term handshaking is consistent with the description of the term elsewhere herein. This is consistent with the notion that the optical tag circuit and reader system may operate without requiring synchronization. Consistent with some embodiments, the decoding scheme is determined without handshaking with the optical tag circuit. Therefore, the encoding, transmission, and decoding of information does not require handshaking or synchronization.

Consistent with some embodiments, the optical tag circuit reader is further configured to compare pixel data for a location incident with the encoded optical signal to pixel data from pixels adjacent to the location. Pixel data may refer to the light signal received by the image capture device, digitized, and provided to the processor. Pixels adjacent to the location may refer to any pixels that may or may not have a light signal, but for which that light signal is not related to the encoded optical signal. These may, for example, include pixels receiving background noise or background light that may provide a baseline light level.

Consistent with some embodiments, the decoding scheme is further configured to handle one or more errors associated with collection of the encoded optical signal by the image capture device to facilitate transmission of the information. Errors may refer to noise, incorrect signals, background levels, skipped data points, readout noise, thermal noise, shot noise, or any other problem that may arise when transmitting the information. Handling these errors properly may contribute to an increase in the fidelity of the information upon transmission. Consistent with some embodiments, one or more errors relate to a read noise during an analog-to-digital conversion of the optical signal. A read noise may be noise occurring during a readout process including conversion, amplification, and processing steps. A read noise may refer to electronic noise during a readout process in a camera, for example.

Consistent with some embodiments, at least one of the one or more errors is caused by a deadzone of the image capture device. A deadzone may refer to a time during which the image capture device is not recording or receiving light. For example, the deadzone could occur when a camera is resetting, a shutter is not open, or data is being read from a detector row or array. Consistent with some embodiments, the deadzone occurs for a deadzone duration greater than 1% of a capture period corresponding to the capture frequency. A deadzone duration may refer to the time duration for a deadzone to occur. A capture period may refer to the time duration during which an image capture device is recording or receiving light.

Consistent with some embodiments, the image capture device is configured to capture the encoded optical signal with a spatial resolution limited by a diffraction limit. A diffraction limit may refer to a fundamental limit or point where two Airy discs are no longer distinguishable from one another. The Airy disc corresponds to the most focused spot of light that a perfect lens with a circular aperture can make, limited by the diffraction of light. As described herein, the diffraction limit may be the spatial resolution limit of the image capture device. The spatial resolution is consistent with the description elsewhere herein. Consistent with some embodiments, the image capture device is configured to capture the encoded optical signal at a spatial resolution limited by the diameter of an Airy disc of an aperture of the image capture device. Often, the diffraction limit is directly related this diameter as a fundamental limit of resolution provided by the imaging system in front of an image capture device.

Consistent with some embodiments, the image capture device is configured to capture the encoded optical signal for a wavelength of light, λ, a distance from the optical tag circuit to a lens of the image capture device, y, and a diameter of an aperture of the image capture device, D, and a diffraction constant, C, with a spatial resolution limited by C*λ*(y/D). This equation may represent a fundamental resolution limit related to the diffraction limit. C, for example, may be 2.44, derived from a calculation of the constant for an Airy disc or an aperture in front of a detector.

Importantly, any of the features recited above and described herein may be used in combination with any of the other features, except where otherwise contradictory, without departing from the scope of the present disclosure.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1A shows an asynchronous optically powered optical tag circuit and reader system implemented, consistent with some embodiments of the present disclosure.

FIG. 1B is a flowchart of interaction between an optical tag circuit and an optical tag reader.

FIG. 2A illustrates an exemplary 2D barcode device encoding information from a physical object.

FIG. 2B shows an optical tag circuit integrated with a physical object, consistent with some embodiments of the present disclosure.

FIG. 3A shows a layout of some components consistent with some embodiments of an optical tag circuit of the present disclosure.

FIG. 3B is a block diagram showing an illustrative flow corresponding to an optical tag circuit, consistent with some embodiments of the present disclosure.

FIG. 3C shows an illustrative optical tag circuit with outer edges of a hypothetical bounding box surrounding the optical tag circuit.

FIG. 4 shows cross-sectional views of an optical tag circuit, consistent with some embodiments of the present disclosure.

FIG. 5 shows cross-sectional views of an optical tag circuit, consistent with some embodiments of the present disclosure.

FIG. 6 shows an optical tag circuit incorporated with a piece of jewelry as well an exemplary time trace of the optical signal output from an optical tag circuit, consistent with some embodiments of the present disclosure.

FIG. 7A shows a block diagram of an optical tag reader according to embodiments of the present disclosure.

FIG. 7B shows optical conditions and corresponding capture of image data of an optical tag circuit by an optical tag reader, consistent with some embodiments of the present disclosure.

FIG. 8A shows spatial resolution limits of an image from a camera when imaging two optical sources that are sufficiently spatially separated to be spatially resolved.

FIG. 8B shows optical resolution limits of an image from a camera when imaging two optical sources that are not sufficiently spatially separated to be spatially resolved.

FIG. 9 shows an asynchronous optical tag and reader system with corresponding time traces, consistent with some embodiments of the present disclosure.

FIG. 10 illustrates temporal signals and mapping of information from a synchronous optical tag circuit and reader system according to the prior art.

FIG. 11 shows temporal signals and mapping of information from an asynchronous optical tag circuit and reader system, consistent with some embodiments of the present disclosure.

FIG. 12 shows temporal signals and mapping of information from an asynchronous optical tag circuit and reader system, consistent with some embodiments of the present disclosure.

FIG. 13 is a block and flow diagram showing an asynchronous optical tag circuit and reader system enabling encoding and decoding of the tag information, consistent with some embodiments of the present disclosure.

FIG. 14 shows a bit map, consistent with some embodiments of the present disclosure.

FIG. 15 illustrates an example of encoding and decoding information using a bit map, consistent with some embodiments of the present disclosure.

FIG. 16 illustrates an example of encoding and decoding information using variable frequency decoding of temporal signals of an asynchronous optical tag circuit and reader system, consistent with some embodiments of the present disclosure.

FIG. 17 shows a table for the variable frequency decoding used to extract tag information, consistent with some embodiments of the present disclosure.

FIG. 18A shows an asynchronous optical tag circuit and reader system operating with multiple pulses per encoded bit, consistent with some embodiments of the present disclosure.

FIG. 18B shows encoding and decoding information using a bit map for an asynchronous optical tag circuit and reader system operating with multiples pulses per encoded bit, consistent with some embodiments of the present disclosure.

FIG. 19 shows a block diagram of a process for decoding information from an asynchronous optical tag circuit and reader system, consistent with some embodiments of the present disclosure.

FIG. 20 shows an optical tag circuit with anti-reflective coatings on select areas, consistent with some embodiments of the present disclosure.

### DETAILED DESCRIPTION OF THE INVENTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the Illustrative methods described herein may be modified by substituting, reordering, removing, or adding steps to the disclosed methods. Accordingly, the following detailed description is not limited to the disclosed embodiments and examples. Instead, the proper scope is defined by the appended claims.

### SYSTEM OVERVIEW

The disclosed embodiments enable optically powered optical tag circuits whose size can be near to or smaller than spatial resolution of a reader device (e.g., a camera) used to capture an optical signal. Optical tag circuits incorporating embodiments of the present disclosure can therefore be used to tag objects without significantly altering an appearance of the object. For example, circuits according to embodiments of the present disclosure may present a length dimension of less than or equal to 0.3 mm and a width dimension of less than or equal to 0.3 mm, such that a surface area of such a circuit is no greater than 0.09 mm2.

As used throughout this disclosure, the term “light emitter” refers to any device configured to output light in response to being provided with electrical energy.

Some of the disclosed embodiments can be implemented to construct devices that can enable receiving more information from an asynchronous optically powered optical tag circuit and reader system than could be encoded spatially in the area containing the optically powered optical tag circuit. As used herein, the term “asynchronous” refers to a configuration whereby no synchronization takes place before, during, or after communication between an optical tag circuit and an optical tag reader. In other words, while the optical tag circuit of the disclosed embodiments may broadcast an optical signal containing information, the optical tag performs the broadcasting without receipt of any external information from a reader capturing the optical signal or other device. This is in contrast to a synchronous system that allows for an active communication, linking, or synchronization of the timing signals between a communicating optical tag circuit and reader device before and/or during capture. As used herein, the term “optically powered” refers to the use of light incident on the optical tag circuit as a power source, for example, to drive components of the optical tag circuit. This enables a configuration of optically powered optical tag circuits that can be used in conjunction with a reader system where information can be linked to an object using a optical tag circuit whose size is near or smaller than the spatial resolution of the camera. This allows for linking information to an object with an optical tag circuit and extracting/decoding the information with an optical tag reader (e.g., a computing device comprising a camera) that is not required to be synchronized to the optical tag circuit, while using an optical tag circuit that is small enough to be used on smaller objects than can be tagged with existing technologies like QR or NFC or to completely dissimulate an optical tag circuit on an object. The optically powered optical tag circuit can also be used to tag an object without significantly altering its appearance.

Throughout the present disclosure, the term “optically powered optical tag circuit” may be used interchangeably with the term “optical tag circuit.” Similarly, the term “optical tag circuit reader” may be used interchangeably with the term “reader” and “optical tag reader”.

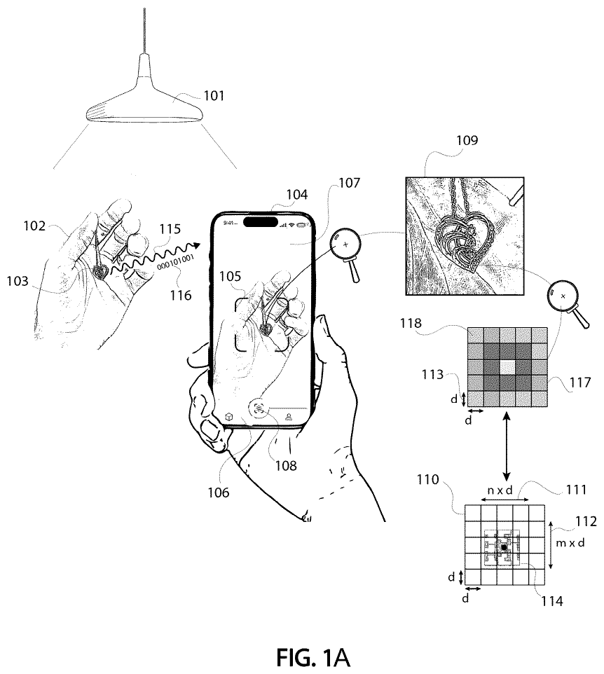

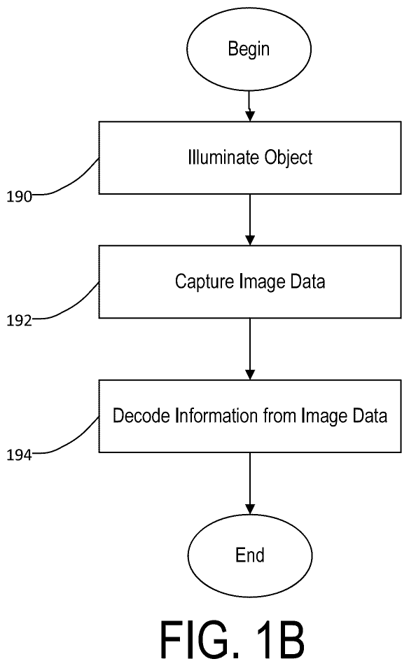

FIG. 1A illustrates an example of an asynchronous optically powered optical tag circuit and optical tag reader system in operation, consistent with some embodiments of the present disclosure. As shown at FIG. 1A, the system may comprise an optically powered optical tag circuit 114 mounted on or in a physical object 103 and configured to provide information via an optical signal, and an optical tag reader 104 configured to asynchronously receive an optical signal from the optically powered optical tag circuit 114.

Circuitry associated with the optical tag circuit 114, which will be described in greater detail below, may be configured to cause a light emitter to emit information 116 as an encoded optical signal 115 at an emission frequency. For example, the optical tag circuit 114 may include a memory storing identifying information related to the optical tag circuit 114 and/or the object 103 on which the optical tag circuit 114 is affixed. Such information 116 stored in the memory may include, for example, a unique identification (ID), a digitized signal corresponding to sensor data (e.g., a temperature of an element on the tagged object), etc. The circuitry may be configured to read the information 116 from the memory and to encode the information 116 into an optical signal 115 emitted by the light emitter and emitted at the emission frequency, as described below.

The circuitry may, therefore, comprise circuitry for on-board digital control, and circuitry for driving pulses of electric current through the light emitter to generate pulses of light at the emission frequency to transmit encoded information 116 from the optical tag circuit 114. For example, the optical tag circuit 114 may be configured, to broadcast an encoded optical signal as light pulses at an emission frequency, for example, ranging between about 94 Hz and 120 Hz (e.g., at approximately 100 Hz). Notably, frequency variability may occur as a result of the materials used and manufacturing process, among other factors, of an individual semiconductor chip, and may range, for example, from about 2-20 percent. For example, a semiconductor chip, e.g., a CMOS chip, set for a nominal frequency of 100 Hz, tolerances may be determined as plus or minus an existing delta for CMOS (e.g., between about 2 and 20 percent). Thus, taking an image capture device having a typical capture frequency of, for example, 240 Hz, an optical tag circuit 114 operating in a range between 94 Hz and 120 Hz, i.e., equal to or less than half of the capture frequency, may be implemented to carry out the functionality described herein. Notably, the range of frequencies described in the present disclosure is illustrative only, and not intended as limiting.

According to some embodiments, the presence of one or more light pulses 115 during a given “bit period” may encode a “1,” while the absence of any light pulses may encode a “0”, such that the timing of detected pulses corresponds to a binary sequence. For example, the optical tag circuit 114 may be configured to provide pulses for a pulse duration, the pulse duration being a fraction (e.g., between about 0.1× and 0.00001×) of a bit period used to provide the information 116, where a pulse in which light is emitted corresponds to a “1” and a pulse where no light is emitted correspond to a “0.” The term “pulse duration” refers to the time during which a light pulse occurs, including, for example, the duration from start to termination of the light pulse, sometimes referred to as pulse width. In some cases, the pulse duration may include a time immediately before or after the pulse, or a time duration that excludes a rise time or fall time of the pulse. The term “bit period” refers to the time duration for encoding, broadcasting or otherwise providing one bit of the information. For example, a bit period may represent a set of pulses inclusive of the duration occurring between the pulses. The bit period may include multiple pulses corresponding to the encoded optical signal comprising the information to be broadcast by the optical tag circuit 114.

FIG. 1B is a flowchart interaction between the optical tag circuit 114 and the optical tag reader 104 illustrated at FIG. 1A. In the example of FIG. 1B, the physical object 103 and hence the optically powered optical tag circuit 114 are illuminated by a light source 101 (step 190), which may include light energy from any of one or more light generating features in the environment of the object 103. It is desirable that the light source 101 provides a sufficient level of incident light such that power for the optical tag circuit 114 may be generated and stored allowing the optical tag circuit 114 to emit an encoded optical signal with a desired efficiency.

The optical tag reader 104 (e.g., a camera of a smartphone) is shown capturing a video composed of frames or single images 109 over time (step 192), and optionally recording images 109 of the physical object 103 on which the optical tag circuit 114 is affixed. During capture of the video and/or single frames, the optical tag reader 104 captures images of the optical tag circuit 114 outputting an encoded optical signal 115 (e.g., as pulses of light). The optical tag reader 104 collects the optical signal 115 emitted from the optically powered optical tag circuit 114 at a particular capture frequency associated with the image capture device of the optical tag reader 104 (e.g., approximately 240Hz).

In the example of FIG. 1A, the image capture device of the optical tag reader 104 and the optically powered optical tag circuit 114 are not synchronized, meaning that the rate at which the optical tag circuit pulses light (i.e., the emission frequency), which corresponds to the optical tag's bit rate, may not be determined or altered by the frame rate of the image capture device, i.e., the timing related to when the image capture device of the optical tag reader collects light for each frame. Indeed, in some embodiments, the optical tag circuit 114 and the optical tag reader 104 may be asynchronous, and in some embodiments, the optical tag circuit 114 and optical tag reader 104 may be completely independent of one another. In other words, according to embodiments of the present disclosure there is no downlink from the optical tag reader 104 to the optical tag circuit 114, and thus no control of the optical tag's bit rate (i.e., the emission rate) from an external system (e.g., the optical tag reader 104) that would otherwise cause synchronization of the frame rate of the image capture device (i.e., the capture frequency) with respect to the output pulses of light 115 (i.e., the emission frequency).

Furthermore, to demonstrate the independence of the optical tag reader 104 and the optical tag circuit 114, when the optical tag circuit 114 is illuminated with continuous light from the light source 101 in the absence of the optical tag reader 104, the emission frequency of light pulses emitted from the optical tag circuit 114 remains unchanged.

In FIG. 1A, the display 107 of the optical tag reader 104 depicts a single frame of the image data captured by the image capture device. The image 109 illustrates a zoomed in area 105 of a frame of the image data captured by the image capture device and centered on the object 103 tagged with the optically powered optical tag circuit 114. As illustrated in FIG. 1A the image capture device may have a predetermined resolution limit of dimension, d 113, wherein any two optical signals 115 that are spatially closer than dimension d 113 may be unresolvable spatially by the image capture device as two separate optical signals 115. While in FIG. 1A the spatial resolution d 113 appears to be similar or approximately the same in both dimensions d 113, in some embodiments, the spatial resolution in the two dimensions 113 may be different. The pixel array 117 illustrates a zoomed in region of the image 109 containing the optical tag circuit 114 where each unit pixel 118 may represent a single unit of area at the spatial resolution of the image capture device. This unit pixel 118 in some embodiments may, for example, be determined by the spatial resolution of the image sensor of the image capture device, the fundamental optical limits of the optical system using for light collection in the image capture device, or a resolution limit accounting for other aberrations associated with the image capture device. In some embodiments, the unit pixel 118 is a single pixel in the output image from the camera's processor. According to other embodiments, the unit pixel 118 is a collection of multiple pixels in the output image of the image capture device that correspond to a total dimension for the resolution limit of the image capture device.

Therefore, processing (e.g., decoding) of the encoded optical signal is performed by a processor of the optical tag reader 104 to obtain the information from the encoded signal (step 194). Decoding of the encoded optical signal is described in greater detail below.

In view of the above, the optically powered optical tag circuit 114 shown in FIG. 1A, may be confined to an area smaller in dimension than a first dimension 111 corresponding to (n*d) and a second dimension 112 corresponding to (m*d) where n and m are integers, as shown at area grid 110, and d is the resolution limit associated with the optical tag reader 104. Notably, according to embodiments of the disclosure, components of the optically powered optical tag circuit 114 may be contained within this defined area, the components including, for example, a power source (e.g., photovoltaics), a light emitter, and the circuitry (e.g., timing, encoding, and driving circuitry for the light emitter). Overall, an optical tag circuit 114 according to disclosed embodiments may provide a total amount of encoded information 116 greater than the corresponding number of bits (m*n) that would otherwise be received by the camera for a spatially define bar code or NFC. For example, for a camera with spatial resolution of 0.1 mm and an optically powered optical tag circuit of outer dimensions 0.29 mm by 0.29 mm, the optical tag circuit 114 would be contained in an area of approximately (3*0.1mm) by (3*0.1 mm). In such an embodiment, the optical tag circuit 114 may output greater than 9 bits of information, which is thus greater than bar code or NFC having the same spatial dimensions (i.e., limited to 9 bits).

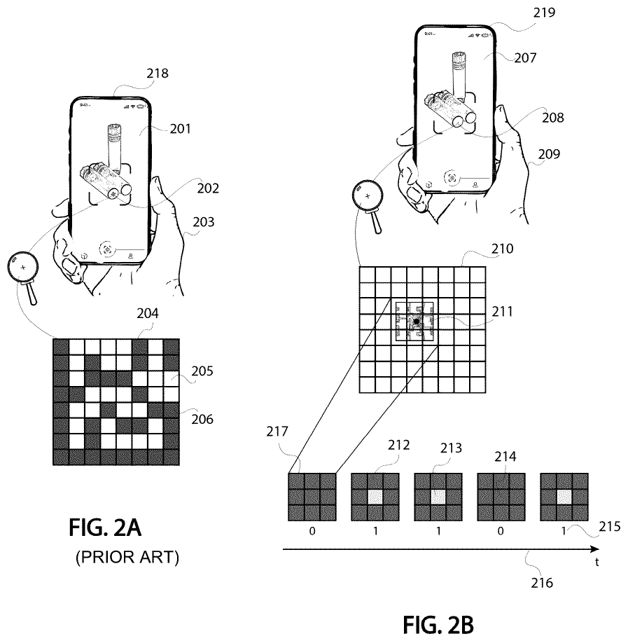

FIG. 2A illustrates an example of spatially encoding information on a physical object using a 2D barcode device, consistent with the prior art. A physical object tagged with, for example, a 2D barcode 202 is captured and the object is displayed on an electronic device's display 201. A barcode image 204 illustrates a zoomed in image of the 2D barcode 202. The information contained in the 2D barcode 202 is encoded spatially with symbols, such as dots, that absorb or reflect different amounts of light. For the information to be received or extracted from a single image taken with the electronic device 218 equipped with a camera, the spatial resolution of the camera has to be sufficient to distinguish each bit of the 2D barcode 202. In FIG. 2A, the camera's resolution is depicted as one of the unit pixels, for example, a light pixel 205 or a dark pixel 206. The area shown may allow for an encoding of 8×8 bits or 64 total bits of information.

FIG. 2B illustrates an example of some disclosed embodiments used to encode information temporally through pulses of light emitted from an optically powered optical tag circuit 208 at an emission frequency and captured by an optical tag reader 219 asynchronously, as described above. In this example, the user 209 captures a physical object tagged with an optically powered optical tag circuit 208 (essentially equivalent to optical tag circuit 114) with an image capture device (in this instance a camera) integrated with an optical tag reader 219 (essentially equivalent to optical tag reader 104) and displayed on a screen 207.

A zoomed in image 210 illustrates a representation 211 of the optically powered optical tag circuit 208 overlayed with a grid, each square of the grid representing a single unit of area at the spatial resolution limit of an image capture device of the optical tag reader 104, i.e., the unit pixel resolution of the image capture device. Depending on the image capture device implemented within the optical tag reader 104, the unit pixel resolution may be a single pixel, or a collection of pixels corresponding to a total dimension of a resolution limit of the image capture. The information contained on the optical tag circuit 208 may be broadcast through pulses of light that are an encoded representation of that information 116. The sequence of grids 217 represents a sequence of images from multiple frames captured by the camera at different times 216, centered on the optically powered optical tag circuit 211. The darkness or lightness of each pixel 212, 213, or 214 represents the amount of light captured by the camera's image sensor at that location. More light corresponds to a lighter illustration of the unit pixel. Less light corresponds to a darker illustration of the unit pixel. Unit pixel 213 represents a unit pixel collecting a large enough amount of light emitted from the light emitter on the optically powered optical tag circuit 211 to be detectable. Unit pixel 214 represents a unit pixel where the light emitter may be located but no light from the optical tag circuit 211 is detected by the camera and hence the unit pixel is dark. For example, by recording a sequence of these images over time, the pulses of light from the optically powered optical tag circuit can be used to extract encoded information 215 from the optical tag circuit 211 temporally as opposed to spatially. As used herein and described elsewhere, “unit pixel” may refer to a region of the image at the size of the resolution limit of the image capture device, which may correspond to a single pixel on the image capture device's image sensor.

In some embodiments, the optical signal will be detected by several adjacent physical pixels, and the signal may be extracted by summing the output of those pixels. Through a series of images taken over time 216, as shown in FIG. 2B. In any event, the optical tag circuit and optical tag reader system presently described can extract more information than could be encoded spatially in the same area, as demonstrated at FIG. 2B.

### OPTICAL TAG CIRCUIT

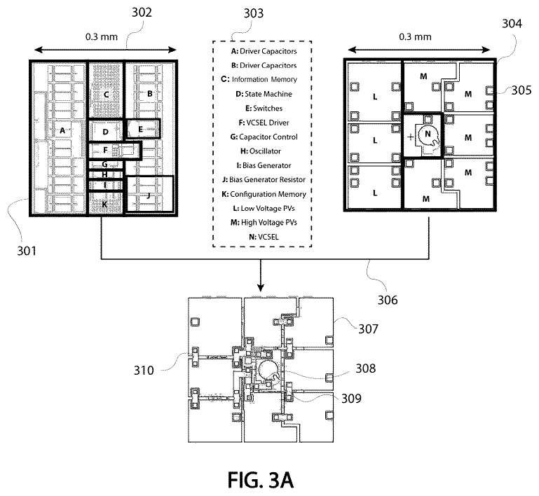

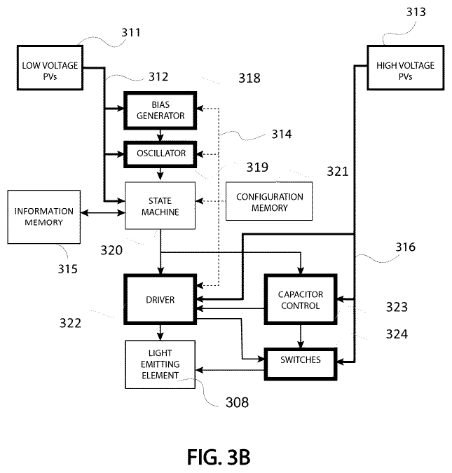

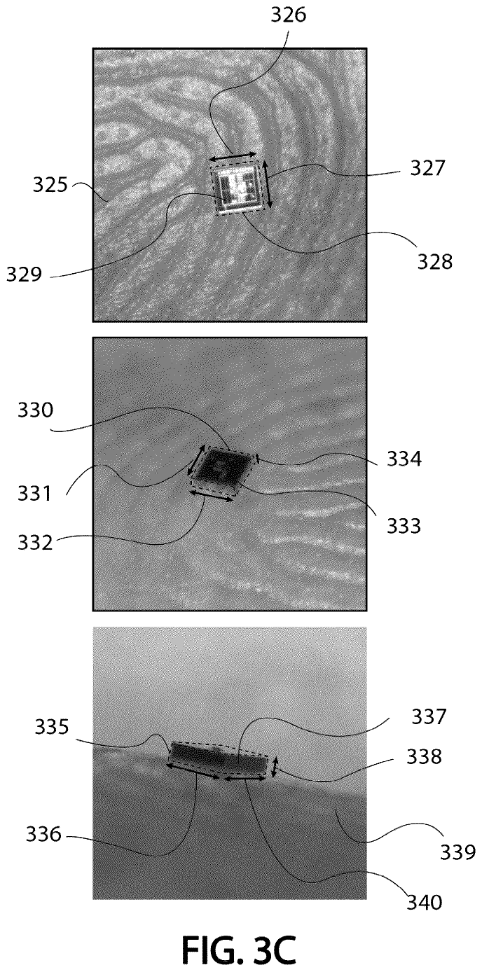

FIG. 3A. shows a layout of some components of an optical tag circuit 307, consistent with the optical tag circuit 114 of FIG. 1, and therefore, embodiments of the present disclosure. The circuitry components in the optical tag circuit 307 may be made from any suitable material and by any suitable process and in any number of layers. For example, a first optical tag circuit component 301 may be formed via complementary metal-oxide-semiconductor (CMOS) on a semiconductor substrate as a first layer, the semiconductor substrate may comprise any suitable material, for example, silicon, gallium arsenide, and Group III/V semiconductors.

The optically powered tag circuit 307 may comprise one or more electric power sources 309 configured to generate an electric current for powering the optical tag circuit 307 using incident light, and a light emitter 308 configured to emit information as an encoded signal at an emission frequency, among other components.

The light emitter 308 (shown at FIG. 3A) may include any suitable element that emits light when electric energy (i.e., a particular voltage and current) is applied to the light emitter. For example, the light emitter 308 may include a diode-based light emitter, e.g., a VCSEL, LED, microLED, RCLED, etc. Throughout the disclosure many of the examples are described in the context of a VCSEL implemented light emitter 308. However, this is not intended to be limiting and any suitable light emitter may be implemented in place of the VCSEL.

The light emitter 308 may be characterized by a turn on voltage (VTO), a threshold current (ITH) and associated threshold voltage (VTH), and a current range with associated voltages where the light emitter 308 transduces electric energy to light with near maximum efficiency.

The power source 309 may include one or more devices configured to generate electric current and provide the electric current to one or more other components of the optical tag circuit 114 as electric energy. As used herein, the term “electric energy” (also referred to as “electric charge”) refers to potential energy as represented by a voltage and kinetic energy as represented by a combination of voltage and current in a circuit. For example, the power source 309 may comprise one or more photovoltaic cells (PVs) configured to transduce incident light to electric energy. As used herein, the term “incident light” is intended to refer to any and all light energy impinging upon pertinent portions of the optical tag circuit 114, including, but not limited to the power source 309 implemented as one or more PVs. For example, the incident light may include incident light comprising a broad spectrum of wavelengths from one or more of ambient light, reflected light, sunlight, light reflected from the optical tag circuit, and light from a mobile device, etc.

According to some embodiments, low voltage PVs may be implemented, the low voltage PVs comprising, for example, two silicon PIN junction photovoltaics configured to provide a total voltage of approximately 1.2 volts at an incident light intensity (i.e., illumination) of 1 milliwatt per square millimeter and approximately 0.8 volts at an illumination of 1 microwatt per square millimeter.

Alternatively, or in addition, the low voltage PVs may be implemented as one or more gallium arsenide (GaAs) PIN junction photovoltaic configured to provide approximately 1.1 volts at an illumination of 1 milliwatt per square millimeter and approximately 0.8 volts at an illumination of 1 microwatt per square millimeter.

Importantly, the values related to output of photovoltaics disclosed herein should be understood to vary, for example, by up to 50 percent according to known aspects, for example, a material property band gap, among other things. An upper end of the range may be limited and may be related to an open circuit voltage of a selected material for the photovoltaic cell, among other things. Therefore, such values are intended as illustrative and not limiting.

In one example, when implemented as one or more photovoltaic cells (PV), the power source 309 may include a plurality of PVs connected in series to provide an electric current proportional to the intensity of incident light on the PV. According to some embodiments the provided electrical current may approach a “short-circuit current” of the PV corresponding to a current when the voltage across the PV is approximately zero.

According to another example, depending on a desired voltage, the power source 309 may be implemented as a plurality of PVs connected in parallel. The parallel connected PVs may be configured to provide an electric current proportional to the intensity of incident light on the PV. The voltage output of the PVs may be related the open-circuit voltage of the photovoltaics which is dependent on illumination conditions. Thus, according to an example, a plurality (e.g., 3) of GaAs PVs wired in parallel may be implemented to create a PV with an effective area of approximately 0.03 mm2.

According to yet another example, a set of high voltage PVs may be provided alone or in conjunction with low voltage PVs, for example, to power a driver circuit for the light emitter 308. According to some embodiments, the high voltage PVs may include eight silicon PIN junction photovoltaics providing a total voltage of approximately 5.2 volts at an illumination of 1 milliwatt per square millimeter and approximately 3.2 volts at an illumination of 1 microwatt per square millimeter. Another embodiment of the high voltage photovoltaics could be five gallium arsenide PIN junction photovoltaic providing approximately 5.5 volts at an illumination of 1 milliwatt per square millimeter and approximately 4 volts at an illumination of 1 microwatt per square millimeter.

A storage element may be configured to receive and store electric energy provided by any suitable power source, e.g., the power source 309. For example, the storage element may be implemented using one or more of a battery, a capacitor, a plurality of capacitors (also referred to as a bank of capacitors), combinations of batteries and capacitors, etc. For example, a capacitor implemented as the storage element may be placed in parallel with the power source 309 and the light emitter 308. Capacitance in such embodiments may range from about 200 pF to about 350 pF, and may be for example, 250 pF for an on-chip capacitor of a desired size (e.g., approximately 50,000 μm2). Notably, the configuration and values discussed with reference to the storage element are illustrative and not intended as limiting.

According to some embodiments, the storage element may be configured such that electric energy is provided from the power source 309 to the storage element (e.g., a capacitor), to charge the storage element with electric energy. For example, during periods where higher intensity incident light impinges upon one or more PVs of the power source 309, a larger amount of electric energy may be provided to the storage element than during periods of low intensity or no light impingement.

As shown at FIG. 3A, components of the optical tag circuit 307 may be comprised on different component wafers for assembly as described below. According to some embodiments, a first optical tag circuit component 301 may include, for example, two large driver capacitors A configured to operate as a power source and storage element for storing electric energy and driving the driver circuitry 322 (shown at FIG. 3B) of a light emitter N (shown in circuit 304), information memory C configured to store the tag information 116 to be optically communicated, a state machine D corresponding to an encoder, and configured to determine the encoding and timing for the information 116 to be broadcast from the optical tag circuit 301, switches E configured to connect the driver capacitors A to the light emitter N, for example, when pulsed, and a driver circuit 322 configured to efficiently drive current through the light emitter N.

The optical tag circuit 301 may further include a capacitor control circuit G configured to regulate charge and voltage related to the driver capacitors for the driver circuit 322, an oscillator circuit H configured to generate a pulsed clock signal for timing control, a bias generator circuit I (e.g., a proportional to absolute temperature (PTAT) circuit configured to create a low current reference signal for low power operation, configuration memory K that may be modified and configured to change the behavior of the optical tag circuit operation, for example, the speed at which the oscillator circuit H creates pulses.

A large bias generator circuit resistor J used in the generation of these small current signals, may also be provided with the first optical tag circuit component 301.

The second optical tag circuit component 304 may include photovoltaics and the light emitter 308 (also labelled as “N” at 304), for example, a VCSEL, and comprising a III-V semiconductor substrate, for example, gallium arsenide. The photovoltaics may include low voltage photovoltaics L connected in, for example, parallel to yield voltages of approximately 1 volt, and high voltage photovoltaics M connected in, for example, series to yield voltages of approximately 5 volts.

The first and second optical tag circuit components 301 and 304 may be assembled 306 using semiconductor processing techniques, that are described below, to produce a complete optical tag circuit 307 complete with interconnects for the light emitter captured, the high voltage photovoltaics in series 309, and the low voltage photovoltaics in parallel 310. For example, the fully integrated optically powered optical tag circuit 307 may have length and width dimensions less than or equal to approximately 0.15 mm, 0.2 mm, 0.3 mm, 0.4 mm, 0.5 mm, or even 0.75 mm, and any value in between for example, 0.47 mm. According to some embodiments, an optical tag circuit 307 may have square dimensions of 0.47 mm by 0.47 mm, with a surface area of a projection of the optical tag circuit <=0.0221 mm2, though square shape is not intended to be limiting and the optical tag circuits of the present disclosure may have any desired shape, e.g., rectangle, rhomboid, etc.

As used herein the length and width dimensions refer to an outer edge of a hypothetical envelope or bounding box surrounding the optical tag circuit 114 at its maximum distances along the corresponding outer edge.

FIG. 3C shows an illustrative optical tag circuit 329 with outer edges of hypothetical bounding boxes surrounding the optical tag circuit. In frames of FIG. 3C, the optical tag circuit 329 is supported on a human finger and magnified, to facilitate comprehension of the size of the optical tag circuit, for example, by enabling a comparison between fingerprint features 325 and the optical tag circuit 329. A hypothetical two-dimensional bounding box 328 is shown in the top frame of FIG. 3C the bounding box 328 having a width dimension 326 and a length dimension 327. The length dimension 327 and the width dimension 326 may be multiplied together to determine the surface area discussed above.

The middle frame of FIG. 3C shows a hypothetical three-dimensional bounding box 330 having an outer edge 333 and surrounding the optical tag circuit 329. As shown, a width dimension 332, a length dimension 331, and a thickness dimension 334 are encompassed by the bounding box 330, and these dimensions may be multiplied together to determine a volume of the optical tag circuit 329. According to some embodiments, the thickness dimension 334 may range between about 0.05 and 0.15 millimeters, for example, 0.1 millimeters. Based thereon, an optical tag circuit having a length dimension 332 of 0.3 millimeters, a width dimension 331 of 0.3 millimeters, and a thickness of 0.1 millimeters, may present a volume of 0.009 cubic millimeters.

The bottom frame of FIG. 3C shows another hypothetical three-dimensional bounding box 335 surrounding another illustrative optical tag circuit 337. In this view, the length dimension 340 and width dimension 336 are shown nearer a support 339, with the thickness dimension 338 shown extending from the support 339.

The optical tag circuits 307 can be singulated and thinned, for example, to obtain a desired size. For example, thinning may be performed such that the thickness dimension is less than 0.1 mm thickness. As used herein, the term “singulated” refers to first making a wafer with an array of tags and processing it by separating (e.g., by cutting) the individual tags apart from one another.

FIG. 3B is logical block diagram of an illustrative configuration for the optical tag circuit 307, enabling a small optically powered optical tag circuit 307 that can efficiently create pulses of light as an encoded optical signal, timed in a manner that does not require synchronized transmission to a camera system, consistent with some embodiments.

The components of the optical tag circuit 307 that have been designated using letters above in the physical representation have been renumbered using reference numerals in the following discussion related to FIG. 3B. As shown at 3B, components may include a set of low voltage photovoltaics 311 that provide a lower power 312 to a bias generator circuit 318, an oscillator circuit 319, and a state machine circuit 320. An example of the low voltage photovoltaics 311 may be two silicon PIN junction photovoltaics providing a total voltage of approximately 1.2 volts at an illumination of 1 milliwatt per square millimeter and approximately 0.8 volts at an illumination of 1 microwatt per square millimeter. Another example of the low voltage photovoltaics may be one gallium arsenide PIN junction photovoltaic providing approximately 1.1 volts at an illumination of 1 milliwatt per square millimeter and approximately 0.8 volts at an illumination of 1 microwatt per square millimeter. The voltage output of the photovoltaics is closely related the open-circuit voltage of the photovoltaics which is dependent on illumination conditions. For example, FIG. 3A illustrates using GaAs photovoltaics and shows three photovoltaics that are wired in parallel to create photovoltaic with an effective area of approximately 0.03 mm2.

To enable photovoltaics to be near or below the resolution of a camera the area available for light collection is limited and the amount of current available from the photovoltaics scales with available area. For example, the available area may be 0.03 mm2 and hence at indoor illumination intensities of 1 microwatt per square millimeter and standard photovoltaic efficiencies, less than 8 nanoamps and 7 nanowatts of power may be available. The optical tag circuit topology described herein enables operation at 3 nW, which is well within the limit of available power.

Further voltage provided by the photovoltaics may vary over illuminations ranging from indoor light conditions to outdoor sunlight illumination of approximately 1 milliwatt per square millimeter. The disclosed circuits are able to operate over a full range of illumination intensities.

The bias generator circuit 318, may receive electric power from the low voltage photovoltaics 311, and is configured to provide an approximately constant low current source for the circuitry to use as a current reference maintaining low power, among other things. For example, the bias generator 318 may be a PTAT reference coupled to a current mirror to provide a current source that varies with temperature. In another example, the bias generator 318 may use a PTAT coupled with a Complementary To Absolute Temperature (CTAT) to create a temperature stable current source. In either case, the PTAT and/or CTAT may supply an approximately constant voltage reference that can be applied to a resistor for correspondingly constant current. The bias generator circuit may use a large resistor to create a small current to be used as the reference current. For example, the resistor values can be as large as 100 megaohms, with reference currents of a 200 picoamps when the reference voltage is applied across them.

The oscillator circuit 319 may be configured to provide a relatively constant-period pulse train signal, for example, using power supplied by the low voltage photovoltaics 311 and the reference current from the bias generating circuit 318, to function as an internal clock available in the optical tag circuit 307, among other things. For example, the oscillator circuit 319 may include a relaxation oscillator, and the reference current charged onto a small capacitor, for example, a capacitor ranging from 100 to 200 femto-Farads, e.g., 150 femto-Farads. The voltage of the small capacitor may be monitored and then discharged once it reaches a desired voltage, for example, approximately equal to the open circuit voltage of silicon (i.e., approximately 0.6V) This process may repeat, creating a periodic clock signal that has relatively constant frequency.

Variation in manufacturing along with effects of temperature may result in variations of the clock frequency. Therefore, although the clock circuit may be designed for a bit rate of 100 Hz, there may be some devices in the optical tag circuit that operate at a range between about 120 Hz to 90 Hz, for example, 100 Hz and 94 Hz, etc. The frequency at which each component operates tends to be relatively stable, that is, it does not change in time except to the extent that a particular component frequency responds to changes in temperature. The temperature variance can be difficult to eliminate in integrated circuits without precision-manufactured off-chip components. However, the variable emission frequency techniques disclosed herein enable optical tags of varying and unknown frequency to operate within the context, provided the frequency is relatively constant over the period of a given operation of the optical tag reader 104.

The state machine 320, also referred to herein as an “encoder,” may be configured to determine when pulses of light are emitted from the light emitter 308 of the optical tag circuit 307. The state machine 320 may be, for example, a digital logic circuit configured to receive the periodic clock signal from the oscillator 319 as well as information from the information memory 315 and may provide a signal to the driver circuit 322 and capacitor control circuit 323 that causes light to be emitted from the light emitter 308 to convey the information stored in the information memory 315. In yet another example, the state machine 320 may be composed of a collection of d flip flop circuits that stores part of the information memory 315 temporality and cycles through the information with each clock cycle from the oscillator 319.

The information memory 315 may be any suitable memory for storing, in a non-volatile manner, information to be communicated by the tag. For example, the information memory 315 may be a set of on-board memory such as read-only memory (ROM) or other non-volatile memory containing unique identification information for the tag, a unique identifier (UID). In another example, the information memory 315 may be information stored on the optical tag circuit 307 related to an onboard sensor capable of sensing characteristics from the environment surrounding the optical tag circuit 307, such as, for example, temperature, humidity, pressure, magnetic field strength, etc.

Consistent with some embodiments, alternatively or in addition, the information may include a unique identifier identifying an object on which the optical tag circuit is mounted. A unique identifier may refer to identifier such as a numeric or alphanumeric string associated with an object. The unique identifier may be a consistent code, string, label, or ID.

Alternatively, or in addition, the information may include a link, for example, to a database. A database may refer to a collection, organization, structure, or network of data or information stored in a computer system or memory. The database may be located locally on the optical tag reader or remotely. For example, the unique identifier may include a link to one or more of a local database and a cloud database. The unique identifier may be linked to digital content in a local or cloud database.

Alternatively, or in addition, the information may include a uniform resource locator (URL) providing a link to a website or other resource available via a network. For example, an optical tag circuit on a product may provide a link to a manufacturer's website to enable interaction related to the product to take place (e.g., user manuals, service requests, etc.)

The optical tag circuit 307 may be further configured to operate with a configuration memory 321 configured to provide additional information for operating parameters of the optical tag circuit. For example, the configuration memory 321 may store configuration information related to brightness of light to be emitted, intensity of incident light to enable operation, data on previous occurrences or use of the optical tag circuit to the bias generator 318, oscillator 319, state machine 320, and driver 322, etc. The state machine 320 may be configured to read the configuration information from configuration memory 321 and to apply the operating parameters derived therefrom to operation of the optical tag circuit 307.

High voltage PVs may be configured to provide higher power output on high power line 316 to one or more of the driver circuit 322, the capacitor control circuit 323, and switches 324. For example, the high voltage photovoltaics 313 could be eight silicon PIN junction photovoltaics providing a total voltage of approximately 5.2 volts at an illumination of 1 milliwatt per square millimeter and approximately 3.2 volts at an illumination of 1 microwatt per square millimeter. Another example of the high voltage photovoltaics may be five gallium arsenide PIN junction photovoltaic providing approximately 5.5 volts at an illumination of 1 milliwatt per square millimeter and approximately 4 volts at an illumination of 1 microwatt per square millimeter. For example, FIG. 3A illustrates an embodiment using GaAs photovoltaics and shows five photovoltaics that are wired in series and supplies a voltage of ~4 volts and 3 nA of current, or ~12 nW of power.

The driver circuit 322 may be configured to charge a capacitor bank from one or more of the photovoltaic stacks 311, 313 and cause discharge of the capacitor bank through the light emitter 308, to emit pulses of light at times determined by the encoder 320. For example, the driver circuit 322 may control switches 324 that connect the capacitor bank to the light emitter 308 when voltages have reached a desired threshold enabling pulses of light from the light emitter 308 at a desired efficiency and disconnect the light emitter 308 to prevent electric energy from reaching the light emitter 308 when voltage at the capacitor bank are below the threshold level. During the time that the capacitors of the capacitor bank are disconnected from the light emitter 308, they may, for example, be charged by the high voltage photovoltaics 313.

To enable the optical tag circuit 307 to output light pulses of a desired intensity, e.g., bright enough to be distinguished from background scattered light by the optical tag reader 104, the driver circuit 322 and capacitor controls 323 may be designed to drive the light emitter 308 in a manner where the number of photons emitted increases to a desired level with increasing illumination intensity. For example, by increasing the capacitance that is charged to the higher voltages supplied by the high voltage PVs 313, the number of photos emitted during a pulse can be achieved.

In another example, the full bank of capacitors may be charged to a level that is linearly proportional to the light illumination and the voltage of the capacitors in the capacitor bank may not be regulated to be a fixed value. In this example, when in higher illumination intensities, the voltage of the capacitor bank will have reached a higher value before discharging.

The capacitor control circuit 323 may regulate the amount of capacitance to be used in the driver circuit 322 and when to use it. For example, at lower light levels the capacitor control circuit 323 can control the driver circuit 322 to only charge a smaller subset of the capacitors available in the capacitor bank and at higher illuminations, all available capacitors in the capacitor bank may be charged.

The light emitter 308 is a component that emits light when current is applied to it. Consistent with some embodiments this could be a VCSEL, LED, or RCLED, as described above. These light emitters may have efficiencies that are dependent on the amount of current conducted through them and the voltage applied. Typically currents needed may be on the order of milliamps. To accomplish high efficiencies, the driver circuit 322, capacitor control 323, and switches 324 are designed to create short pulses of currents that may efficiently drive the light emitter 308, due in part, to power constraints on circuits of the sized described herein. For example, a 12 nW optically powered optical tag circuit configured to continuously deliver milliwatt levels of power to the light emitter 308 can be enabled to do so using the techniques described herein. Such a circuit may, for example, make efficient, bright pulses every 100 Hz by charging the capacitors for approximately 10 milliseconds and then discharging all of the charge collected in 100 nanoseconds. The optical tag circuit driver and switches may be designed to be able to deliver these short rapid pulses to enable this efficient driving of the light emitter 308 while operating with low power based on, for example, one or more thresholds measured at the high voltage PVs and/or the capacitor bank (e.g., voltage, current, etc.)

### OPTICAL TAG CIRCUIT FABRICATION

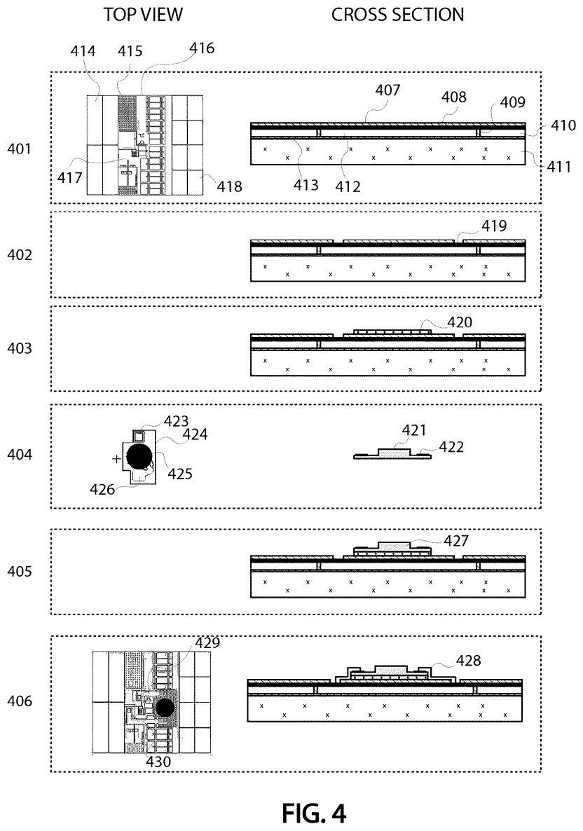

FIG. 4. is a cross section of an optically powered optical tag circuit showing its fabrication, consistent with embodiments of the disclosure. The optically powered circuit may integrate silicon photovoltaics, a complementary metal oxide semiconductor (CMOS) circuit, and a III-V light emitter 308, among other things. View 416 at stage 401 illustrates a top view of the optical tag circuits core silicon-based circuit 417 and photovoltaics 414 and 418.

According to some embodiments, there may be a section of top metal 415 that can be used, for example, to hard wire in static information into the optical tag circuit such as a unique identification code and/or other desired information.

The optical tag circuit may have separate electrically isolated low voltage photovoltaics 414 that provide power to the digital control circuitry. These low voltage photovoltaics 414 may be wired in series and/or in parallel to create an operating voltage that is approximately twice that of the open circuit voltage of silicon, for example, ranging between about 600 mV and 800 mV.

Another set of electrically isolated high voltage photovoltaics 418 may provide power to the light emitter driver circuitry. Photovoltaics 418 may be wired in series to create an operating voltage that ranges between approximately 6 to 9 times that of the open circuit voltage of silicon, for example 8 times the open circuit voltage of silicon.

A cross section of the optical tag circuit's silicon-based components are shown in the right of stage 401. The substrate in which the CMOS circuitry and photovoltaics may be fabricated may use a silicon-on-insulator substrate. The CMOS circuitry may be, for example, a 180 nm node silicon-based CMOS that may be produced using standard semiconductor processing.

The substrate handle layer 411 may have a layer of insulated buried silicon dioxide (BOX) 413 on a top surface.

The photovoltaics may be isolated with a deep trench isolation 409 comprising, for example, oxide materials. Regions 412 and 410 of the device are layered in the silicon on insulator (SOI) substrate that may contain CMOS electronics and/or diodes that may be configured to operate as photovoltaics.

The CMOS top metal 408 may be covered with an oxide material 407.

To incorporate a light emitter into the optical tag circuit, in step 402 openings in the top oxide 419 to the top metal may be made, for example, using photolithographic patterning and reactive ion etching.

In stage 403 a thin adhesive layer 420 may be patterned at a location where the light emitter is to be transferred to promote adhesion. For example, a layer of SU8, BCB, or other polymer may be patterned on a top surface of the CMOS top metal 408.

In stage 404, on a separate substrate, such as, for example, a III-V wafer like GaAs or GaN, a light emitter 421 (in top view) and 424 (in profile view) may be fabricated using semiconductor processing. For example, the light emitter can be a light emitting diode (LED), a Vertical Surface Cavity Emitting Laser (VCSEL), or a resonant cavity LED (RCLED), consistent with embodiments of the disclosure.

Electrical contacts to the anode and cathode of the light emitter 424/421 are shown as 422, 426, and 423 at stage 404. The mesa 425 of the light emitter 424/421 may be where light can be emitted from the light emitter 424/421.

At stage 405, the light emitter 424/421 can be transferred to the SOI substrate using various techniques such as, for example, elastomer-based stamp transfer, thermal slide transfer with selective etching, etc.

Following the transfer of the light emitter now referenced as 427 (see stage 405), an electrical interconnect stage 406 is performed, and electrical interconnects 428 can be established, for example, photolithographically and/or through various other microelectronic interconnect techniques such as, for example, bump bonding, wire bonding, or flip chip bonding.

Notably, the light emitter transfer stage 405 and electrical interconnect stage 406 may be combined into a single processing stage. The right image in 406 shows the completed optically powered optical tag circuit combining silicon photovoltaics, silicon-based CMOS, and a III-V light emitter complete with electrical interconnects 429 and 430 in profile view.

Following assembly, an encapsulation layer such as, for example, oxides (silicon, nitride, alumina, etc.), parylene, or other polymers can be applied to the wafer to encapsulate the optical tag circuit.

The resulting semiconductor processing of stages 401 through 406 can result in an array of optically powered optical tag circuits. To singulate, or make the optical tag circuits into individual optical tag circuits, the wafer can be thinned using, for example, chemical mechanical polishing (CMP) to dimensions less than, for example, 0.1 mm and then diced into individual components.

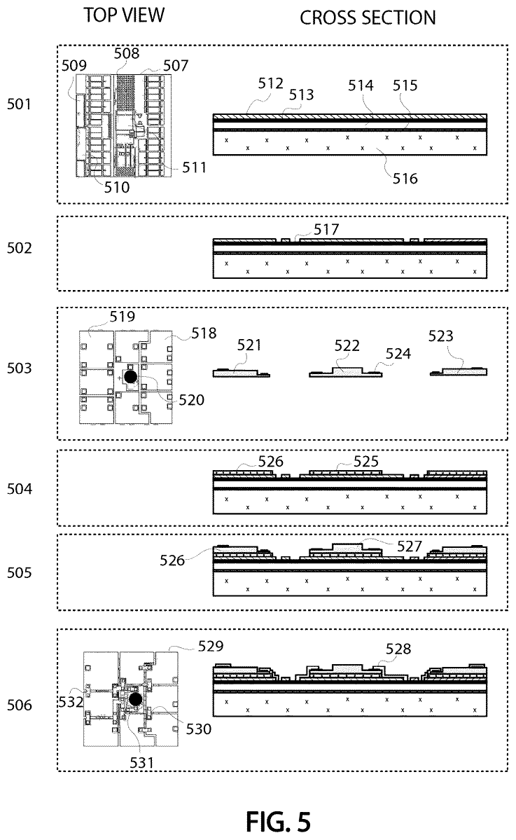

FIG. 5 is another cross section of an optical tag circuit showing its fabrication, consistent with some of the disclosed embodiments. For example, the optically powered circuit may integrate a CMOS circuit, III-V semiconductor-based photovoltaics, and a III-V light emitter. The stages of FIG. 5 may be similar to the stages illustrated in FIG. 4, with certain differences. For example, in stage 503 the photovoltaics and light emitter (e.g., VCSELs) may be patterned. According to such an example, the photovoltaics and VCSELs can be patterned on the same III-V substrate, such as gallium arsenide, or can be made on different substrates.

In step 504 an adhesive layer can be applied for both the light emitter and the photovoltaics. The VCSELs and photovoltaics may be transferred 505, interconnects can be patterned 506, encapsulation applied, and devices singulated as described above.

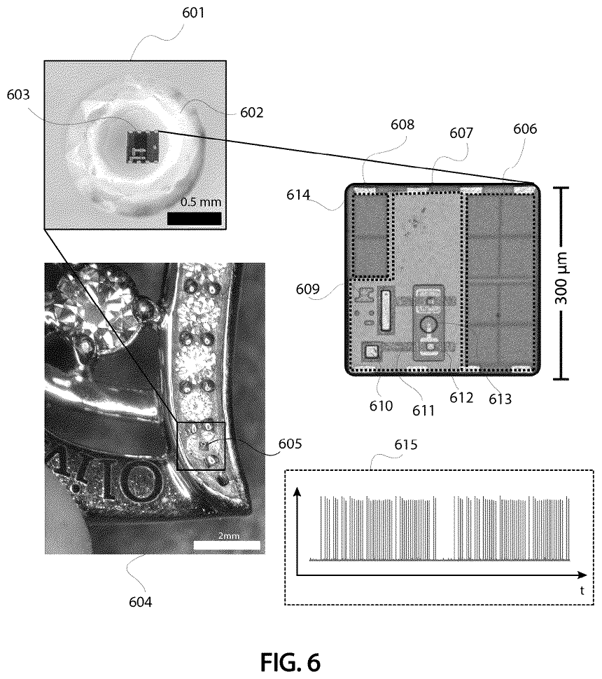

FIG. 6 shows images of an optical tag circuit 603 mounted on a physical object 602, consistent with some embodiments. For example, a singulated optically powered optical tag circuit 603 may be incorporated into a piece of jewelry. Image 601 shows an image of an approximately 0.3 mm×0.3 mm×0.03 mm optically powered optical tag circuit 603 mounted, for example, via an adhesive (e.g., epoxy resin), to a gem. The gem 605 is incorporated into a piece of jewelry as shown in image 604. The image 604 has been captured via a microscope. A zoomed in image of the optical tag circuit 603 is shown in 614, and corresponds to the optical tag circuits described above. Particularly, the optical tag circuit 603 includes of a set of low voltage silicon photovoltaics 608, high voltage silicon photovoltaics 606, a CMOS circuit 607, a microLED 613, photolithographically defined interconnects between the light emitter and the CMOS 611 and 610, and non-volatile information memory 609 that has been photolithographically defined.

A representation of an encoded optical signal including the information from information memory 609 as captured from the optical tag circuit 603 as a function of time t is shown in 615, where the short pulses emitted from the optical tag circuit 603 are apparent.

The components may be fully integrated using the semiconductor processing methods described above to create a tiny optically powered optical tag circuit 603. For a given optical tag reader 104, e.g., a smartphone camera as of the date of filing of the present application (e.g., Apple iPhone™ 14, Samsung Galaxy™ S23, etc.), the optical tag circuit 603 when imaged from about 1 meter would occupy a single unit pixel at the resolution of the camera.

### OPTICAL TAG READER

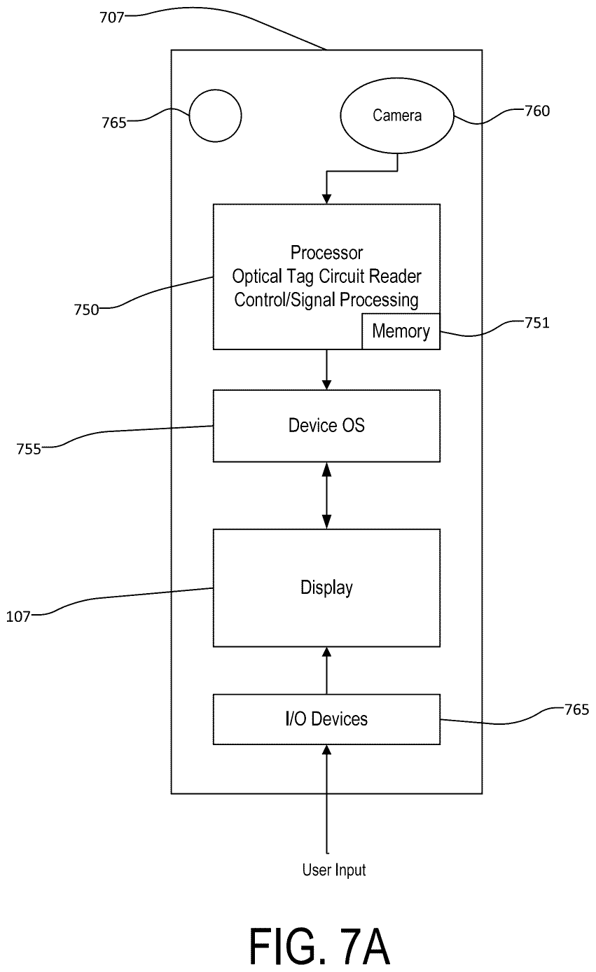

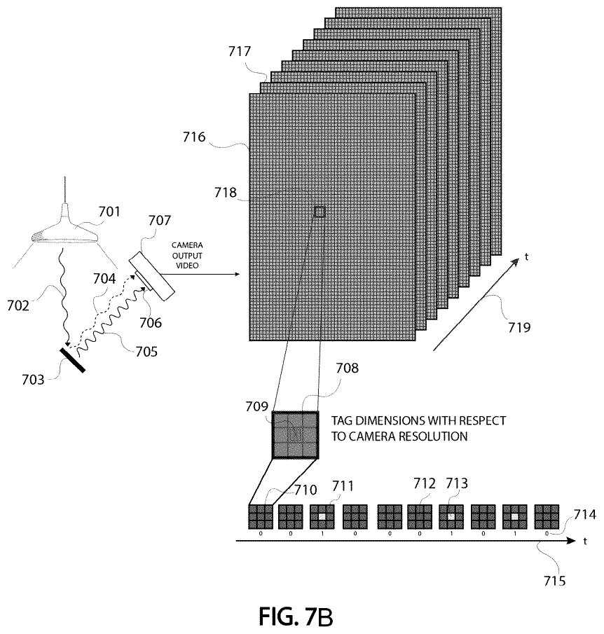

FIG. 7A shows a block diagram of an optical tag reader 707, corresponding to the optical tag reader 104 of FIG. 1A, and therefore, according to embodiments of the present disclosure. In the following, FIG. 7A will be discussed in conjunction with FIG. 7B, which shows optical conditions and corresponding capture of image data of an optical tag circuit 703 by the optical tag reader 707, consistent with some embodiments of the present disclosure.

The optical tag reader 707 may comprise any suitable device for capturing and processing an optical signal 115. For example, the optical tag reader 104 may comprise a smartphone, a video camera, or a dedicated reader. When the optical tag reader is implemented in a smartphone, the smartphone may comprise a portable computing device with one or more cameras, image capture devices, and/or detectors 760, a display 107, and a processor configured for optical tag circuit reading and signal processing 750, among other things. The smartphone may be configured to perform multiple functions related to both optical tag reading and information extraction, and may implement an operating system 755 capable of running one or more task specific applications, among other things.

The optical tag reader 707 may be configured to capture an encoded optical signal from an optical tag circuit. For example, at a wavelength of light, λ, a distance from the optical tag circuit 114 to a lens of an image capture device of the optical tag reader, y, and a diameter of an aperture of the image capture device, D, with a diffraction constant, C, a spatial resolution of the camera 760 may correspond to C*λ*(y/D). Thus, the camera 760 may be configured to capture an encoded optical signal at a spatial resolution limited by the diameter of an Airy disc of an aperture of the image capture device.

The optical tag reader 707 may be configured to asynchronously receive an optical signal 705 at a capture frequency that can be different from the frequency at which the optical tag circuit 703 operates, i.e., without transmitting data to or handshaking with the optical tag circuit 703. For example, a capture frequency of the camera 760 may range between about 100 Hz and 300 Hz (e.g., about 240 Hz) based on, for example, the type and quality of the camera implemented, among other things, while, in some embodiments, the emission frequency of the optical tag circuit 703 may be between about 90 Hz and 120 Hz.

While the capture frequency of the optical tag reader 707 may be different than the emission frequency of the optical tag circuit 703, according to embodiments of the disclosure, the emission frequency of the optical tag circuit 703 may not be altered by or for the benefit of the optical tag reader 707, due to the asynchronous nature of the broadcast from the optical tag circuit 703. Therefore, processing of the image data captured by the image capture device of the optical tag reader 707 may be performed to decode the optical signal 705 and to obtain the information encoded therein as described below.

The display 107 may comprise one or more interfaces enabling various information to be output in a user readable format to a user of the optical tag reader 707. For example, the display 107 may be configured to provide a digital rendering of information in user readable format. The display 107 may include one or more of an LED display, an OLED display, an LCD display, etc. which may be configured for rendering the information in a human-viewable manner. Alternatively, or in addition, while the term “display” is used herein, the output may be provided in, for example, audio format to enable a user to “listen” to the information obtained from an optical tag circuit. Moreover, embodiments of an optical tag reader consistent with the present disclosure need not have structure to present information received from an optical tag circuit to a user. Instead of being displayed, for example, the information could be stored on the reader or relayed elsewhere.

The optical tag reader 707 may further include one or more input devices 765 for receiving user input. For example, optical tag reader 707 may include a touchscreen, a keyboard, a mouse, etc. enabling user input.

The optical tag reader 707 comprises at least one processor 750 configured for optical tag circuit reader control and signal processing. For example, the processor 750 may be configured to control components of the optical tag reader 707 to obtain information in an encoded optical signal generated by the optical tag circuit 703 and captured by the camera 760.

Functionality of the processor 750 may be implemented in hardware, software, or any combination thereof. For example, the processor 750 may be programmed, via an optical tag reading specific application executed within the operating system 755 of the optical tag reader 707, to decode an optical signal received from the optical tag circuit 114 and to provide the information in a user readable format on the display 107. According to such an example, the processor 750 may include a memory 751 storing the instructions that when executed by the processor 750 cause the processor 750 to perform the desired functions. Alternatively, the memory 751 may comprise at least a portion of the memory of the optical tag reader 707, for example, when the optical tag reader 707 is implemented as smartphone.

Applications consistent with embodiments described herein implemented on the optical tag reader 707 may be coded in any suitable format and language, for example, based on the operating system 755 of the optical tag reader 707. For example, an application configured for receiving an encoded optical signal captured by an image capture device of the optical tag reader 705, determining a decoding scheme based on the encoded optical signal, and decoding the encoded optical signal to obtain and optionally provide information encoded in the optical signal, may be developed and installed on the optical tag reader 707, and coded according to one for one or more standards of the iOS™ operating system from Apple™ and/or the Android™ operating system from Google™. Coding of any such applications is understood to be within the capacity of one of skill in the art upon review of the present disclosure.

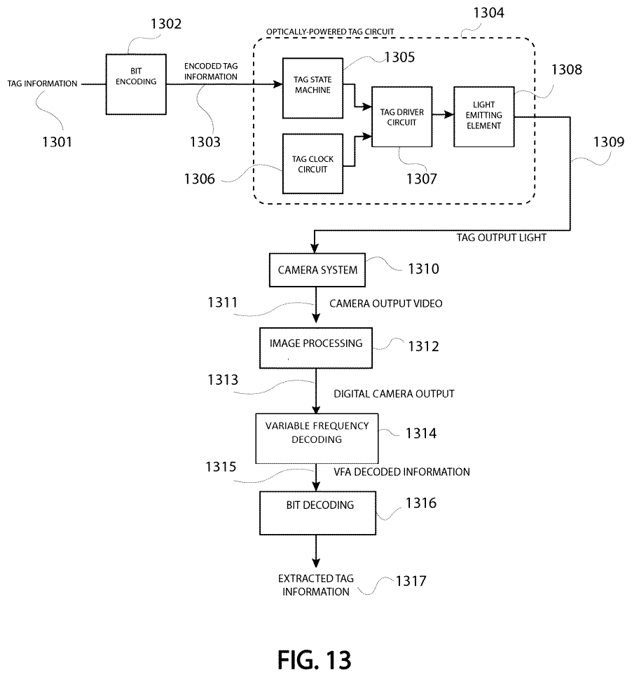

FIGS. 13-19 discussed in greater detail below, describe functionality performed by the processor 750 based on implementations in hardware, software, or combinations thereof.

The optical tag reader 707 may be configured to use one or more of image stabilization and tracking to track an encoded optical signal from the optical tag circuit 703. Image stabilization may refer to a technique used to reduce blurring or loss of information in images due to motion of a device. Tracking may refer to a technique to follow an object or signal over a series of images. Use of both of these techniques may help to facilitate a higher fidelity in the exchange of information from the optical tag circuit 703 to the reader 707 without handshaking between the two devices.

According to some embodiments, the optical tag reader 707 may include one or more light sources 765 configured to generate light for shining on the optical tag circuit 703 to aid in powering of the optical tag circuit 703. For example, the optical tag reader 707 may include an LED configured to provide white light in a flashlight and/or flash photography mode. Alternatively, or in addition an optical tag reader (e.g., in a smartphone embodiment) may be provided with an add-on light generator (e.g., a lamp) powered by, for example, a USB port of the optical tag reader and configured to generate broad spectrum light.

As shown at FIG. 7B, a light source 701 may emit a illumination 702 (e.g., broad spectrum light) that may be incident on the optically powered optical tag circuit 703. A video, or a collection of sequential periodic images, of the optical tag circuit 703 may be captured by an optical tag reader 707 with light collecting optical components 706. Light from the illumination source 702 may impinge on the optical tag circuit and then scattered (e.g., reflected) from the optical tag circuit 703 as scattered light 704, subsequently collected by the optical tag reader 707.

Typically, light incident on the optical tag circuit 703 may scatter in many directions. The camera may also be configured to collect light 705 emitted from the optical tag circuit 703 (i.e., the encoded optical signal). For example, the optical tag's light emitter may be implemented as a VCSEL which may concentrate the emitted light into a narrow emission angle with a full-width half-max angle of ten to twenty degrees.

According to another example, the optical tag's light emitter may be an LED which emits light in a Lambertian emission pattern.

The image data from the camera may be composed of many frames or images, as illustrated by images 716 and 717, taken over a period of time t 719. The image data captured by the camera can be thought of as composed of an array of unit pixels, with each unit pixel having a dimension corresponding to the spatial resolution of the camera. The light collected from the optical tag circuit 703, both the scattered light and the light from the light emitter, may be focused onto a region of the camera image sensor that can be mapped onto the corresponding area in the output video image 718. Region 708 shows the corresponding region zoomed in with an overlay of the optical tag's corresponding boundaries 709 to illustrate that, for example, the dimensions of the optical tag circuit may correspond to a size smaller than a single unit pixel of the camera, and therefore, beyond the resolution of the camera.

An illustration of the sequence of images of region 718 from each of the frames from the video is shown in 710. When the light emitter of the optical tag circuit is not emitting light, the unit pixel may be dark as in 712. The unit pixel's brightness or value is determined by the amount of background scattered light 704 that was collected and may show up in adjacent pixels 711. When the optical tag circuit has emitted a bright pulse captured by the camera with the shutter open, the unit pixel may be bright 713. The unit pixel's value in this case can be determined by the addition of both background scattered light 704 and the optical tag circuit's emitted light 705.

To be detectable, the signal-to-noise ratio of these two signals should be sufficient to confidently determine that the optical tag circuit has emitted a pulse of light. For example, when the optical tag circuit emits a pulse, an encoding of a binary ‘1’ may occur, and when the optical tag circuit does not emit a pulse, an encoding of a binary ‘0’ may occur. A digital output value extracted from a unit pixel for the time trace 715 is listed below each frame. For this recording, the camera's digital output would be ‘0010001010’ suggesting the optical tag circuit emitted at least three pulses of light distinguished from the background. Means for ensuring sufficient confidence are discussed in greater detail below.

### READER RESOLUTION

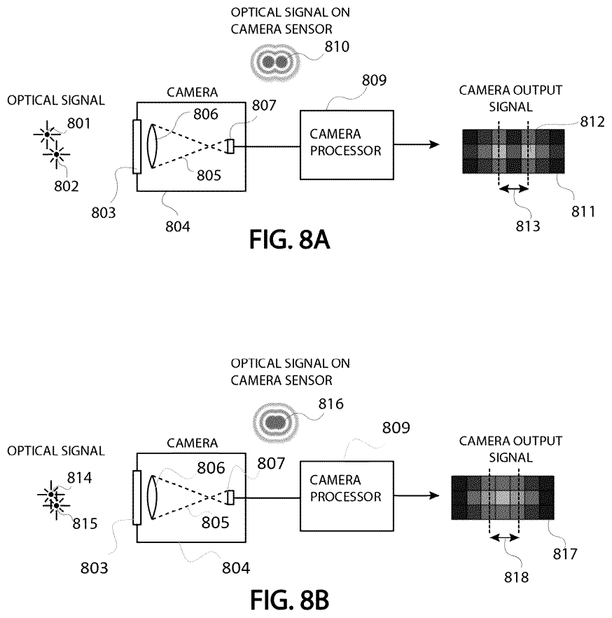

FIG. 8A and FIG. 8B illustrate image capture devices (e.g., cameras) of an optical tag reader capturing two optical signals 801 and 802, and 814 and 815, respectively. In FIG. 8A the two point-sources may be separated by a distance, d. Light may be collected through an aperture 803 and onto a lens system 806 configured to focus the light 805 onto an image sensor 807. The signal from the image sensor may be processed by the camera processor 809 and the resulting camera output video image may be shown 811 as a collection of pixels that have varying light intensity values.

The corresponding image of the optical signals may have sufficient contrast to distinguish them as two separate sources 810 separated by the corresponding longer dimension 813.

In FIG. 8B, the optical sources 814 and 815 may be closer than a distance, d. The resulting image from the camera processer is shown in 817. In this case, the corresponding image of the optical sources may not be resolved as two separate sources and may appear as one combined source 816. In this case, the camera system can be thought of as having a spatial resolution limit, d, wherein the separation distance between the optical sources 814 and 815 may have a shorter dimension 818 that is less than d. For example, the unit pixel may have dimension, d, and be composed of two pixels from the camera's output image.

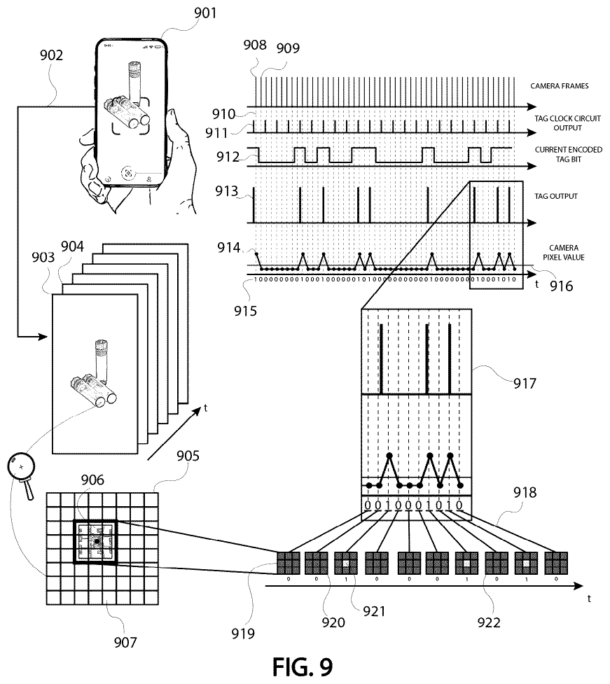

FIG. 9 shows an optically powered optical tag circuit and optical tag reader system along with plots, according to disclosed embodiments. As shown at FIG. 9, a user may capture image data (e.g., a video, multiple still frames, etc.) using an optical tag reader, for example, a camera-containing smartphone 901. The output video 902 may contain a sequence of frames 903 over time t, wherein the optical tag circuit and the object on which the optical tag circuit is mounted may both be imaged.

Image 905 is a zoomed in illustration of the array of unit pixels 907 overlayed with an image of the optical tag circuit 906 to show that the entire optical tag circuit may have dimensions allowing it to be contained in a 3×3 array of unit pixels, for example. Frames 908 and 909 illustrate when the end of a frame has occurred with the time between them being the time during which the shutter of the camera was open and collecting light. The frames are plotted as a function of time t. For example, the camera of the optical tag reader may have a capture frequency of 240 Hz (i.e., frame rate of the camera) and the spacing between frames may be periodic. Dashed lines 910 may be used as a guide to visualize the temporal alignment of other events to when the camera frames end.

The optical tag's clock circuit output 911 is also shown corresponding to time. The clock circuit output 911 may represent the periodic pulses from the optical tag's oscillator circuit 319. The periodic pulses may occur on a periodic basis but have not been synchronized with the timing, frame rate, or frames of the camera via a handshake or downlink from the optical tag reader. For example, the pulses may occur at 100 Hz, as described above.

The encoded tag bit 912 from the optical tag circuit's encoder 320 is shown. This may correspond to the digital output from the encoder 320 that, if high during the clock circuit pulse, may result in a pulse of light from the optical tag's light emitter. If this value is low, during the clock circuit pulse, it may result in no pulse of light from the optical tag's light emitter. The optical tag circuit may output a binary ‘1’ from the encoded tag bit for a pulse of light and a binary ‘0’ for no pulse of light. The corresponding pulses of light 913 are shown.

The value of the unit pixel 907 or pixels, or camera pixel value 914 from collecting light from the optical tag circuit is shown. For example, the camera pixel value may correspond to one of the red, blue, or green pixel output values. In another example, an image processor may be implemented to increase the signal-to-noise ratio by additional operations, such as, for example, first or second order derivatives of adjacent frames or subtraction of averaged neighboring pixel values. A threshold 916 can be set below which the camera digital output 915 may be a binary ‘0’ and above which may be a binary ‘1.’ This threshold may be, either static or adaptive. For example, when a measured brightness does not saturate an image sensor of the image capture device, then an adaptive threshold may be implemented, while a static threshold may be implemented in cases of image sensor saturation. In other words, where amplitude information may be available (i.e., non-saturation), an adaptive threshold may be more useful.

Box 917 illustrates zooming into a region of the plots shown at FIG. 9, while element 918 illustrates the region of the image corresponding to which the camera digital output may correspond. For example, a 3×3 array 919 of unit pixels 907 over time may be dark 920 or light 921 where the optical signal is, or may be dark in the adjacent pixels 922. For example, in the third frame, a pulse of light has been captured as a binary ‘1’ but for the frames before and after it, no pulse of light was captured.

The following plots follow the representation of the optical tag circuit camera system described in FIG. 9.

When communicating digital information rapidly for wired connections, such as a USB drive or internet connection, often at least two channels of information containing data and timing signals can be connected. This can typically be a periodic clock signal that may occur with a pulse or transition, and a data value that goes between a low and a high state. Every time the clock signal occurs, the system may check at what level the data value is and record the value. Other than system errors from noise of other sources, there may be no ambiguity when to check for data or what the value of the data is at that time.

In very high speed wired links, where nearly all bandwidth can be employed for carrying data, clock-and-date recovery circuits may be employed to extract the clock from the transitions of the data itself. However, in such systems, it can typically be the case that 1) the data signal may span the entire bit period (“symbol” period if multiple bits are encoded at once) and 2) the time resolution available to the compressed data representation (CDR) circuit may be much higher than the data period itself, allowing the recovered clock to be closely aligned with the data.

The present inventors have recognized that the optically powered optical tag circuit can produce pulses of light from a single light emitter and hence is limited to one channel of communication for both data and timing information to infer when the optical tag's clock signal occurs. Therefore, some form of CDR function becomes desirable. Furthermore, the optical tag circuit and the optical tag reader system can be asynchronous as defined above, with the time resolution of the reader not much finer than a bit period of the tag, which may induce rounding errors when trying to reconstruct the clock.

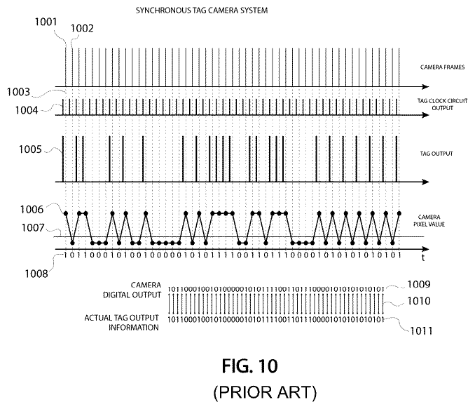

FIG. 10 shows a pulse graph and related data encoding for a synchronous optical tag circuit and camera system according to the prior art. Frames 1001 and 1002, dashed lines 1003, optical tag clock circuit output 1004, optical tag circuit output 1005, camera pixel values 1006 and 1007, and digital values 1008 are shown in a manner consistent with FIG. 9. If the optical tag circuit and camera system were synchronous, with both the optical tag circuit and camera timing signal aligned and running at a bit rate of 240 Hz, for example, as shown in FIG. 10, the mapping 1010 between the camera's digital output 1009 and the tag's output 1011 would be a trivial one-to-one unique mapping. Every frame would have one clock signal occur in the frame and would have a digital output of ‘1’ for every optical tag circuit output encoded as a ‘1’ and a digital output of ‘0’ for every optical tag circuit output encoded as a ‘0.’

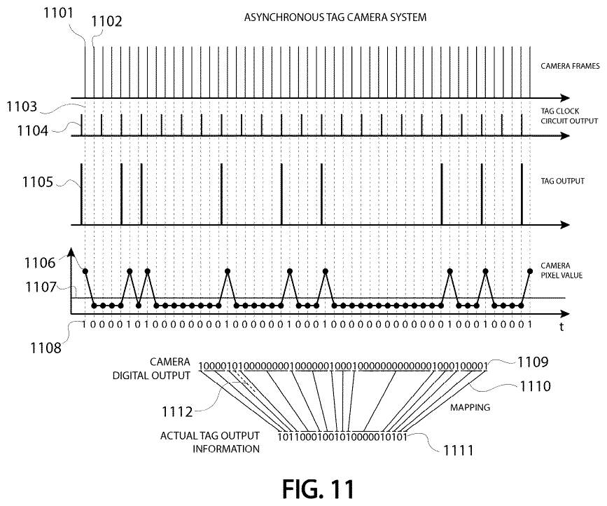

FIG. 11 shows a pulse graph and related data encoding for an asynchronous optical tag circuit and reader system, consistent with some embodiments. For the example of FIG. 11 it is assumed that the reader is always in capture mode to capture light, and the information output by the optical tag circuit is any arbitrary string of ‘0’s or ‘1’s, for example. Frames 1101 and 1102, dashed lines 1103, optical tag clock circuit output 1104, optical tag circuit output 1105, camera pixel values 1106 and 1107, and digital values 1108 are shown in a manner consistent with FIG. 9. As can be seen, in an asynchronous system, the resulting mapping 1110 that may be used to decode and extract the optical tag circuit output information uniquely and correctly from the camera's digital output 1109 to produce the actual optical tag circuit output information 1111 may no longer be immediately discernable. Because of the pulsed nature of the tag's optical signal, any difference between the frame rate of the camera (i.e., the capture rate) and the bit rate of the optical tag circuit (i.e., the emission rate) (e.g., where the frame rate is faster than the bit rate) can result in additional ‘0’s between deliberately encoded ‘1’s and ‘0’s. Some number of binary ‘0’s from the reader's digital output 1109 should therefore be omitted 1112 as shown. The number of zeros between ‘1’s in the reader's digital output can be mapped to a different number of ‘0’s in the optical tag circuit output information. In contrast to a standard CDR approach, where the sampling period of the camera may be adapted to align with the bit period, in the asynchronous system the excess ‘0’s can be identified and removed.

According to some embodiments, an image capture device of a reader may not be capturing light at all times. Indeed, cameras (e.g., smartphone cameras) generally have some amount of deadzone time where they are not recording light between frames, for example, for shuttering to reduce the amount of light exposure for a frame, due to other electronic limitations such as the time to reset pixels or the time needed to read data out from each row, etc. In the majority of commercially available cameras, the deadzone is typically less than or equal to approximately 1 millisecond.

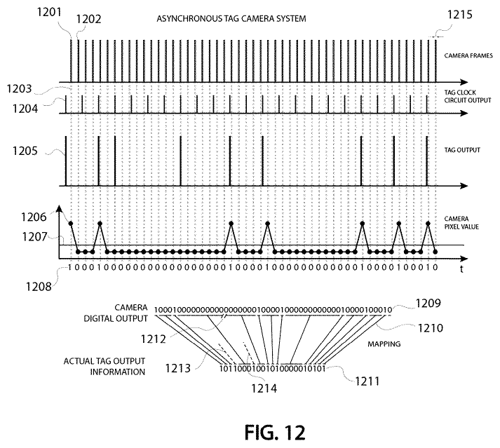

FIG. 12 shows temporal signals and mapping of information from an asynchronous optical tag circuit and reader system, consistent with some embodiments of the present disclosure. Frames 1201 and 1202, dashed lines 1203, optical tag clock circuit output 1204, optical tag circuit output 1205, camera pixel values 1206 and 1207, and digital values 1208 are shown in a manner consistent with FIG. 9. In FIG. 12, for example, the camera may have a non-zero amount of deadzone, and the information may be output by the optical tag circuit with any arbitrary string of ‘0’s or ‘1’s. In this scenario, if one of the short pulses of light from the optical tag circuit occurs during the deadzone, it may not be captured by the camera. Bits of information could be lost. Hence, according to this embodiment, the complex mapping 1210 between the camera's digital output 1209 and the optical tag's output information 1211 may be further complicated by optical tag circuit output information meant to be a binary ‘1’, such as 1213 and 1214, having no corresponding camera digital output of a ‘1,’ and instead having a ‘0.’

FIG. 13 shows a block and flow diagram of an asynchronous optically powered optical tag circuit 1304 and camera system, consistent with embodiments of the present disclosure. The optical tag information 1301 that may be desired to be broadcast from the optical tag circuit may be encoded using, for example, a bit encoding 1302 that can output binary information that may be a unique one-to-one mapping of the optical tag information 1301.

The output encoded tag information 1303 may then be input into the optical tag's state machine circuit 1305. For example, the output encoded tag information 1303 may be stored in non-volatile memory that can serve as the optical tag circuit's information memory. In another example, the optical tag information 1301 may be generated on the optical tag circuit using one or more sensors and then encoded on the optical tag circuit (e.g., to the optical tag circuit's information memory) with a bit encoding circuit 1302.

The optically powered optical tag circuit 1304 may then output pulses of light from the light emitter 1308, where the pulses may correspond to the encoded tag information 1303 and be timed based on, for example, the optical tag circuit state machine 1305, optical tag clock circuit 1306 and optical tag driver circuit 1307.

The optical signal 1309 may then be captured by a reader system 1310 (e.g., a camera) resulting in image data 1311 (e.g., video data, multiple still frames, etc.) An image processing algorithm 1312 may then be applied to locate one or more optical tag circuits 1304 and output a digital output 1313 corresponding to a binary sequence, where for every identified optical tag, every frame may be encoded into either a binary ‘1’ or ‘0’. For example, different images of adjacent frames may be taken, and the brightest pixels identified to locate potential optical tag circuit locations. In another example, tracking and stabilization of the image(s) may be done by image processing, to track the location of the one or more optical tag circuit(s) and allow detection and decoding of the received optical signal, even when the reader and/or te tagged physical object may have moved. In yet another example, image processing may include the first or second order derivatives of images. In another example, image processing may include the location and encoding of multiple optical tags simultaneously. The digital output may then be decoded using a variable frequency algorithm (VFA) 1314, for example. The VFA decoded information 1315 can then be decoded with the bit decoding 1316 to provide the decoded optical tag information 1317. Excluding errors that result from noise or other systematic errors, the optical tag information 1301 and the decoded tag information 1317 should be nearly identical, for example.

### ENCODING AND DECODING OF TAG INFORMATION

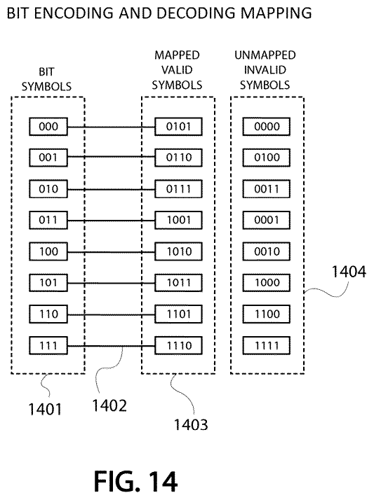

FIG. 14 shows a diagram related to bit encoding and decoding of the optical tag information 1301, consistent with embodiments of the disclosure. For example, the bit encoding and decoding may involve taking binary bit symbols 1401 of certain length (e.g., three bits) and mapping 1402 them to a subset of valid symbols 1403 of a different length (e.g., four bits). A set of unmapped and invalid four-bit symbols are listed in 1404. The mapping 1402 may be unique and one-to-one. This example of bit encoding may be designed so that no mapping of the three symbol bits to four symbol bits results in three ‘0’s in a row. This may be helpful for the variable frequency decoding disclosed below.

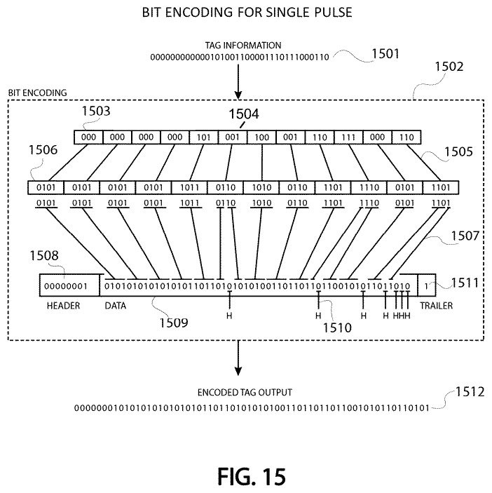

FIG. 15 illustrates an exemplary diagram of bit encoding, consistent with embodiments of the present disclosure. Optical tag information 1501 may be provided as input to the bit encoder 1502. The optical tag information 1501 may be split into three-bit symbols such as shown at 1503 and 1504.

The three-bit symbols can then be mapped 1505 using the mapping, consistent, for example, with FIG. 14. The resulting valid four-bit symbols 1506 may then be mapped using 1507 to the positions shown in the data block 1509. Hamming code bits for error correction 1510 may then be inserted to the positions shown. For example, the hamming codes may be selected using the hamming coding Hamming (63,57), or any other suitable code set.

A header 1508 may be inserted in front of the encoded data and can be composed of a long string of zeroes and a single binary ‘1’. The trailer 1511 may be a single binary ‘1’ at the end of the string, for example. The header and trailer may be configured to allow for more accurately determining the start and end of the encoded tag output 1512. This may be useful for determining an optical tag's emission frequency accurately enough to enable variable frequency decoding, among other things. The encoded tag output 1512 may correspond to the binary combination of the header, data, and trailer.

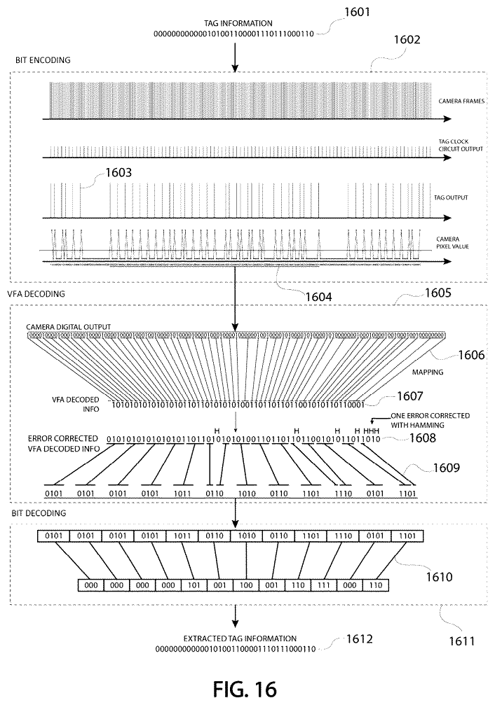

FIG. 16 shows a set of inputs and outputs from an asynchronous optically powered optical tag circuit and camera system, consistent with embodiments of the disclosure. For example, the tag information 1601 may be encoded using the bit encoding shown in FIG. 15 and output from an optically powered optical tag circuit as an encoded optical signal.

The optical tag circuit's state machine may cause the light emitter to emit a pulse of light for every binary ‘1’ in the encoded tag information and no pulse of light 1603 for every binary ‘0,’ going sequentially through the tag information 1601 every clock cycle from the oscillator 319. For example, the optical tag's clock circuit may be periodic with a frequency of 100 Hz, the camera may capture frames periodically with a capture frequency (i.e., frame rate) of 240 Hz, with no synchronization between the two systems.

A section of the digital camera output may be input to the variable frequency (VFA) decoding 1605. The section of digital camera output 1604 may be selected using the preamble and trailer that can allow for determination of a clear start and end to the data packet. The unique mapping of the digital camera output to VFA decoded information 1607 is shown by element 1606. The hamming codes present in the VFA decoded information may then be used to correct a single error resulting in the error corrected VFA decoded information 1608. The error may be the result of a pulse of light occurring during the camera's deadzone, for example.

The four symbol bits that are not hamming codes may then be mapped 1609 as the output from the VFA decoding. The bit decoding 1611, consistent with that shown in FIG. 14, may then be used to map 1610 the four-bit symbols to the three-bit symbols and then concatenated to output the decoded tag information 1612.

The optical tag information and the decoded tag information should match, showing the successful extraction of the tag information using an asynchronous optically powered optical tag circuit and camera.

### EXAMPLE—OUTPUT DATA RATE TO FRAME RATE RATIO

For this example, 36 bits of unique information was extracted from about 0.7 seconds of a camera with a capture frequency at 240 Hz, resulting in approximately 50 bits per second for an information rate on the 240 frames per second camera. The ratio of the optical tag's output data rate in bits per second to the camera's frame rate in frames per second achieved was therefore approximately 0.2. Notably, the fundamental information limit for this ratio may be 1 corresponding to a synchronous system where information is not further encoded in the amplitude of the signal, for example.

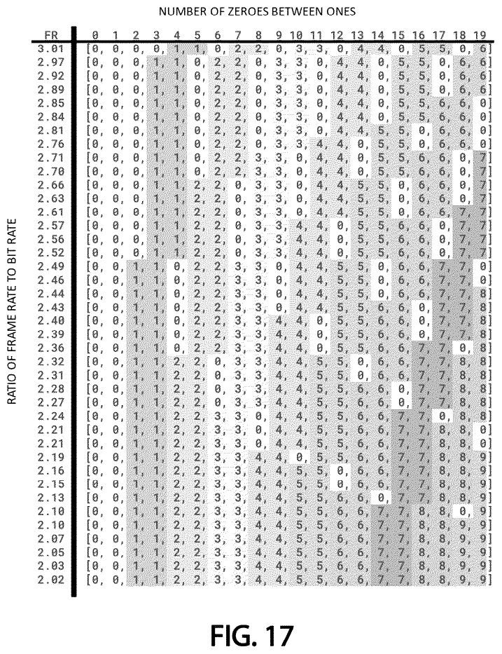

FIG. 17 shows a table for variable frequency decoding used to extract tag information, consistent with some embodiments of the present disclosure, consistent with embodiments of the present disclosure. For example, using a header and a trailer as described above in the optical tag's output, along with additional information of when pulses are occurring, the optical tag's emission frequency and/or bit rate, Fb, may be estimated. The bit rate may not correspond to the information or data rate. For example, the data rate or information rate may refer to the rate at which unique bits of information are broadcast from the tag. The bit rate may be the frequency corresponding to the rate at which bits are broadcast by the optical tag. The camera frame rate or capture frequency, Ff, may be known or determinable. The ratio of the frame rate to the bit rate, Ff/Fb, can be called FR. The variable frequency algorithm may take a string of binary values and map the ones and zeroes to an appropriate number of ones or zeros. For example, the map correlates any occurrence of a one with adjacent zero such as the one in ‘010’ to ‘1’ and any occurrence of multiple ones next to one another with adjacent zeroes such as the ones in ‘0110’ to ‘1.’ For zeroes, the VFA decoding may use the lookup table of FIG. 17 to determine how to map several (N) ‘0’s in a row to some other number M of ‘0’s.

The lookup table in FIG. 17 may have rows corresponding to FR values, the columns may correspond to the number of ‘0’s between ‘1’s minus one (N−1), and the entry may be the number M of ‘0’s to map them to. For example, for the string ‘10000001’ there are 6 zeroes between the two ones. For an optical tag circuit with FR =2.40, such as an optical tag circuit with frequency 100 Hz and a camera with frame rate 240 Hz, the row shows FR =2.40 and in column 5, there are 2 zeroes, so that ‘10000001’ should map to ‘1001.’

The lookup table of FIG. 17 and VFA decoding may be designed with a choice of bit encoding to provide unique mappings that can lead to the correct extraction of optical tag information under varying conditions.

Some embodiments for the bit encoding and the variable frequency decoding can be generalized for implementing in a restricted bit encoding where outputs are limited to having ‘0’s that occur in integer multiples of, for example, 2, 3, 4, etc. which can then be used with corresponding variable frequency decoding to create unique mappings of data.

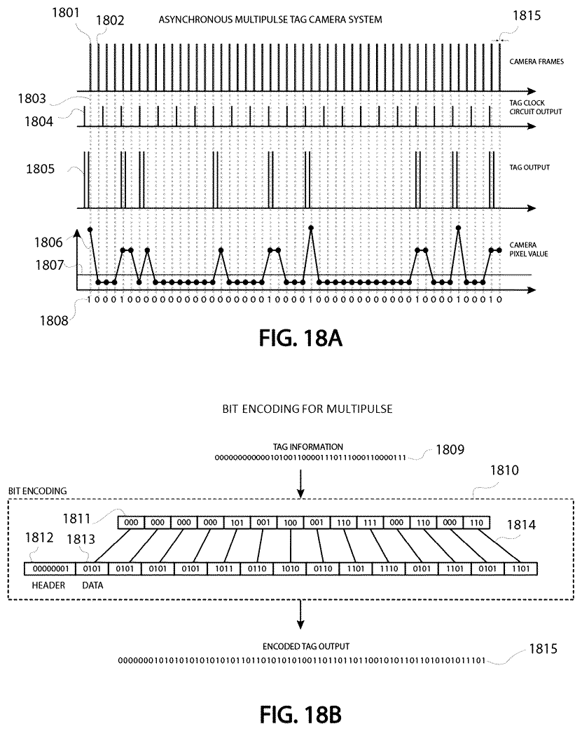

FIG. 18A shows an output graph for an optically powered optical tag circuit with multiple pulses of light per bit of information, consistent with some embodiments of the disclosure. Frames 1801 and 1802, dashed lines 1803, tag clock circuit output 1804, optical tag circuit output 1805, camera pixel values 1806 and 1807, and digital values 1808 are shown in a manner consistent with FIG. 9.

The multiple pulses of light can be called multipulse. For example, the optical tag circuit may output two pulses of light 1805 per bit encoded as a ‘1’ where the space between the two pulses may be greater than the deadzone time (e.g., approximately 1 millisecond) but less than ¼ of the frame rate. This can guarantee that for deadzones <¼ of the frame rate, the two pulses may never both occur during the deadzone. This can serve as a method for guaranteeing that bits of information may not be lost during a camera's deadzone. More generally, for a fraction of the frame when pulses occur, D, a largest frequency ratio, max(Ff/Fb), and a the number of pulses occurring in the duty cycle window, P, then this technique may allow for shuttering or deadzones under the condition that max(ff/fb)*D−1<shutter<1−max(ff/fb)D/(P−1), where shutter is the fraction of the frame that is deadzone.

FIG. 18B illustrates an exemplary bit encoding for multipulse, consistent with some embodiments. An optically powered optical tag circuit operating with multipulse may also function asynchronously with a camera system to extract tag information 1809. The bit encoding 1810, consistent with that shown in FIG. 14, may then be used to map 1814 the three-bit symbols 1811 to the four-bit symbols 1813 and then concatenated as the output extracted tag information 1815, along with a header 1812.

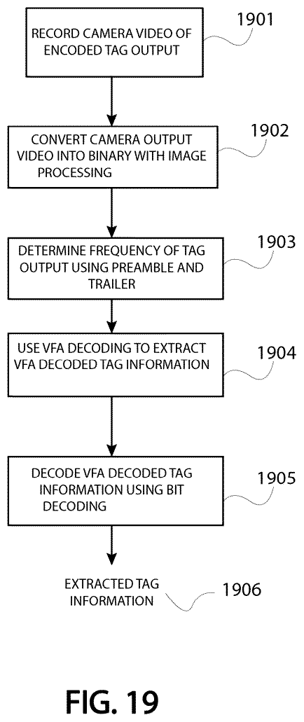

FIG. 19 illustrates a block diagram of the decoding of tag information, consistent with some embodiments. This may include the conversion of the camera output 1901 to convert camera output video into binary with image processing 1902. The frequency of the tag's output may then be determined using the preamble and trailer 1903. The VFA decoding to decode tag information 1904 and the bit decoding to extract tag information 1905 are then used to provide the extracted tag information 1906.

### MODIFICATIONS

It should be appreciated that the above-described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

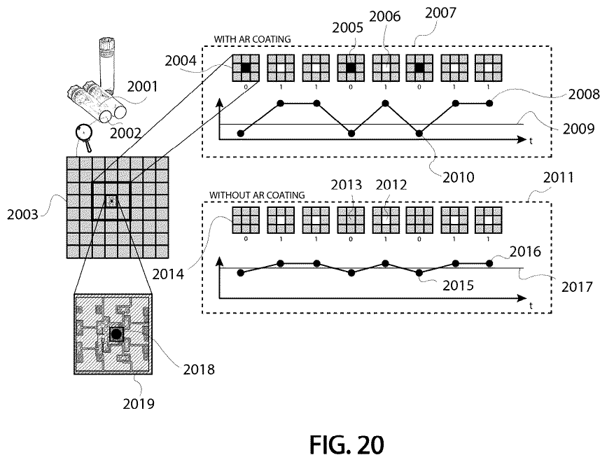

FIG. 20 illustrates an optically powered optical tag circuit 2002 with an anti-reflective (AR) coating applied 2019, consistent with some embodiments. The optical tag circuit 2002 may be imaged on an object 2001 with a camera having a pixel array 2003. For example, the AR coating may be selectively applied spatially by applying the AR coating only to regions of the optical tag circuit where the light emitter emits light, such as the aperture of a VCSEL 2018.

According to some embodiments, the AR coating may be applied to one or more interconnects exposed on a surface of the optical tag circuit. For example, all metallic interconnects that may be impinged upon by light may be coated with the AR coating.

In another example, the AR coating may have a bandpass filter at the emission wavelength of the light emitter.

By applying these AR coatings selectively to the optical tag circuit, the signal-to-noise ratio of the digital camera output can be improved as illustrated in 2007 and 2011. Without the AR coating, in a 3×3 array of pixels 2014, for example, the contrast between the camera's image of where the optical tag circuit is located when it is putting out a pulse of light 2012 versus when it is not emitting light 2013 the signal-to-noise may not be high. With the AR coating, in a 3×3 array of pixels 2004, for example, the contrast between the camera's image of where the optical tag circuit is located when it is putting out a pulse of light 2006 versus when it is not emitting light 2005 can be increased significantly (e.g., on the order of 3×, or more, for example 4× or even 10×b).

According to yet another example, a plurality of tags may be used on a single object. For example, in order to communicate a variety of different information from one object, a first optical tag circuit comprising a first dimension X and a second optical tag circuit comprising second dimension Y may be oriented such that the first optical tag circuit is adjacent to the second optical tag circuit and a combination of the first optical tag circuit and the second optical tag circuit comprises a combined dimension X+Y. The combined dimension may be less than a minimum dimension such that without magnification, the first and second optical tag circuits are not resolvable as two distinct optical tag circuits from a distance of 1 meter. In the present context the term resolvable is taken relative to a human being having uncorrected normal eyesight, or normal eyesight when corrected.

According to another example, the optical tag reader 104 may be configured to capture one or more images of the object on which the optical tag circuit is mounted, and to identify visual characteristics of the object. For example, the optical tag reader 104 may include one or more machine learning engines trained and configured to identify features of objects on which the optical tag circuit 114 is mounted, and determine a type of the object. Returning to FIG. 6, the trained machine learning engine may receive images of the object 602, and based on features of the object (e.g., curves, color, transparency, etc.) determine that the object is a gemstone. A processor of the reader device may then compare the decoded optical tag information and compare the decoded information with information regarding a type of object on which the optical tag circuit having the same information is believed to have been mounted on. Where the visual characteristics and object type determination match the original optical tag circuit mount information, a validation may occur and be communicated to a user of the optical tag reader 104. Alternatively, where a mismatch occurs, the user may be notified (e.g., via the display 107 on the optical tag reader 104) that a mismatch has been determined.

According to yet another example, the optical tag circuit may be configured to increase a brightness of light from the light emitter, for example, over a plurality of orders of magnitude of an intensity of the incident light such that the optical tag reader is able to determine the information. For example, the configuration memory of the optical tag circuit may include a lookup table correlating incident light intensity to desired output light intensity. By referencing the lookup table based on a current intensity of incident light, the optical tag circuit may adjust the brightness of the light emitted from the light emitter such that the emitted light is sufficiently bright to be detected by the optical tag reader in view of the lighting conditions.

Further, non-transitory computer readable media storing instructions that when executed by a processor implement systems or carry out methods of the present disclosure are contemplated by the present inventors. For example, an app configured to transform a smartphone into an optical tag reader 104 as described herein via execution of instructions within the app, is intended to fall within the scope of the present disclosure.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described. Various embodiments are described by the following set of clauses:

Clause 1. A system configured to provide information via an optical signal, comprising:
an optical tag circuit comprising:
an electric power source configured to generate an electric current for powering the optical tag circuit from incident light; and
a light emitter configured to emit the information as an encoded optical signal at an emission frequency;
an optical tag circuit reader, comprising:
an image capture device configured to capture the encoded optical signal at a capture frequency without requiring synchronization of the capture frequency to the emission frequency; and
a processor configured to obtain the information from the encoded optical signal.

Clause 2. The system of clause 1, wherein the capture frequency is different from the emission frequency.

Clause 3. The system of any of clauses 1-2, wherein the optical tag circuit is configured to operate with no downlink from the optical tag circuit reader.

Clause 4. The system of any of clauses 1-3, wherein the incident light comprises a broad spectrum of wavelengths from one or more of ambient light, reflected light, sunlight, light reflected from the optical tag circuit, and light from a mobile device.

Clause 5. The system of clause 4, wherein the smartphone comprises at least one processor configured to use one or more of image stabilization and tracking to track the encoded optical signal.

Clause 6. The system of any of clauses 1-5, wherein the optical tag circuit reader and the optical tag circuit communicate without handshaking.

Clause 7. The system of any of clauses 1-6, wherein the reader is a mobile device and the image capture device comprises a camera mounted on the mobile device.

Clause 8. The system of clause 7, wherein the mobile device is a smartphone.

Clause 9. The system of any of clauses 1-8, wherein the electric power source comprises at least one photovoltaic cell.

Clause 10. The system of any of clauses 1-9, wherein the electric power source comprises:
a first photovoltaic cell stack configured to provide a first voltage to the optical tag circuit; and
a second photovoltaic cell stack configured to provide a second voltage, higher than the first voltage, to the light emitter.

Clause 11. The system of clause 10, wherein the electric power source further comprises at least one power storage device configured to store electric power provided by one of the first photovoltaic cell stack and the second photovoltaic cell stack.

Clause 12. The system of any of clauses 1-11, wherein a ratio of the rate of information obtained in bits per second to the capture frequency in frames per second is less than 0.1.

Clause 13. The system of any of clauses 1-12, wherein the image capture device is further configured to capture one or more images of an object on which the optical tag circuit is mounted, and wherein the processor is configured to identify visual characteristics of the object.

Clause 14. The system of clause 13, wherein the unique identifier further comprises a link to one or more of a local database and a cloud database.

Clause 15. The system of clause 13, wherein the unique identifier further comprises a link to a database.

Clause 16. The system of any of clauses 1-15, wherein the optical tag circuit comprises an integrated circuit configured to encode the information and provide timing and power pulses.

Clause 17. The system of any of clauses 1-16, wherein the information comprises a unique identifier identifying an object on which the optical tag circuit is mounted.

Clause 18. The system of any of clauses 1-17, wherein the optical tag circuit further comprises a clock generation circuit configured to provide a steady bit rate to provide the information.

Clause 19. The system of any of clauses 1-18, wherein the electric power source is further configured to accumulate electric energy transduced from the incident light and release the accumulated electric energy as a pulse configured to drive the light emitter.

Clause 20. The system of clause 19, wherein the light emitter comprises a vertical-cavity surface-emitting laser (VCSEL).

Clause 21. The system of any of clauses 1-20, wherein the VCSEL is configured to emit light in a conical emission profile.

Clause 22. The system of clause 20, wherein the VCSEL is configured to emit light in a scattered pattern.

Clause 23. The system of clause 20, wherein the VCSEL is configured to emit light in a wide emission area.

Clause 24. The system of clause 19, wherein the electric power source is configured to provide the pulse for a pulse duration, the pulse duration being approximately 10000 times less than a bit period to provide the information.

Clause 25. The system of clause 24, wherein a number of photons emitted by the light emitter during the bit period is greater than one percent of the photons in the incident light during the bit period.

Clause 26. The system of any of clauses 1-25, wherein the electric power source is further configured to provide the electric current while receiving less than 10 microwatts per square millimeter of incident light.

Clause 27. The system of clause 19, wherein the optical tag circuit comprises:
an integrated circuit comprising an encoder configured to generate the encoded optical signal and a pulse generator configured to trigger the pulse; and
a plurality of semiconductor optoelectronics configured to transduce the incident light to electric energy.

Clause 28. The system of clause 27, wherein the optical tag circuit is further configured to receive data from one or more sensors and store the data as the information in a memory configured to be read by the encoder.

Clause 29. The system of any of clauses 1-28, wherein the encoded optical signal comprises a binary encoding such that a 1 corresponds to a state when light is emitted by the light emitter and 0 corresponds to the state when there is no light emission by the light emitter, and 0s occur in groups of 2*N, wherein N is an integer.

Clause 30. The system of clause 29, wherein the encoded optical signal further comprises a finite integer limit for a number of zeros repeated in a sequence.

Clause 31. The system of any of clauses 1-30, wherein an area of the optical tag circuit measured as a first dimension X times a second dimension Y is less than 9 square millimeters.

Clause 32. The system of any of clauses 1-31, wherein a first optical tag circuit comprising a first dimension X and a second optical tag circuit comprising second dimension Y oriented such that the first optical tag circuit is adjacent to the second optical tag circuit and a combination of the first optical tag circuit and the second optical tag circuit comprises a combined dimension X+Y that is less than a minimum dimension related to a unit pixel resolution of the image capture device, the first and second optical tag circuits are not resolvable as two distinct optical tag circuits from a distance of 1 meter.

Clause 33. The system of any of clauses 1-32, wherein the light emitter is configured to emit light when the incident light comprises an intensity less than 10 milliwatts per square millimeter.

Clause 34. The system of any of clauses 1-33, wherein the optical tag circuit further comprises a configuration memory storing one or more of predefined brightness information and predefined emission frequency of the light emitter.

Clause 35. The system of any of clauses 1-34, wherein the information comprises at least two distinct features separated by a predetermined number of bit periods to estimate a ratio of the emission frequency to the capture frequency.

Clause 36. The system of any of clauses 1-35, wherein the optical tag circuit is further configured to generate a plurality of pulses to cause the light emitter to emit light in an information transmission period, wherein a first duration between each pulse of the plurality of pulses within an information period is greater than a second duration corresponding to a readout time of the image capture device and less than half of the information transmission period.

Clause 37. The system of any of clauses 1-36, wherein at least some of the incident light originates from the reader.

Clause 38. The system of any of clauses 1-37, wherein the optical tag circuit is further configured to increase a brightness of light from the light emitter over a plurality of orders of magnitude of an intensity of the incident light such that the reader is able to determine the information.

Clause 39. The system of any of clauses 1-38, wherein the processor is further configured to decode the optical signal using a decoding scheme to translate information from a ratio of the variable frequency of pulses corresponding to the optical signal to a frame rate frequency of the image capture device.

Clause 40. The system of clause 39, wherein the decoding scheme is further configured to handle one or more errors associated with collection of the encoded optical signal by the image capture device to facilitate transmission of the information.

Clause 41. The system of clause 40, wherein at least one of the one or more errors is caused by a deadzone of the image capture device.

Clause 42. The system of clause 41, wherein the deadzone occurs for a deadzone duration greater than one percent of a capture period corresponding to the capture frequency.

Clause 43. The system of any of clauses 1-42, wherein the processor is further configured to decode the optical signal using a decoding scheme to provide the information for a plurality of ratios of the emission frequency to the capture frequency.

Clause 44. The system of any of clauses 1-43, wherein the image capture device is configured to capture the encoded optical signal with a spatial resolution limited by a diffraction limit.

Clause 45. The system of any of clauses 1-44, wherein the image capture device is configured to capture the encoded optical signal for a wavelength of light, λ, a distance from the optical tag circuit to a lens of the image capture device, y, and a diameter of an aperture of the image capture device, D, and a diffraction constant, C, with a spatial resolution limited by C*λ*(y/D).

Clause 46. The system of any of clauses 1-45, wherein the image capture device is configured to capture the encoded optical signal at a spatial resolution limited by the diameter of an Airy Disc of an aperture of the image capture device.

Clause 47. An optical tag circuit for providing information via an optical signal, comprising:
a power source configured to transduce incident light to an electric current for powering the optical tag circuit;
a light emitter configured to emit an optical signal in response to an electrical pulse;
an encoder configured to encode the information and provide the encoded information as an electrical pulse to the light emitter;
wherein a first dimension, X, approximated to an integer n, and a second dimension, Y, approximated to an integer m, of the optical tag circuit are configured such that for a given unit pixel resolution, d, a first area defined by X*Y is less than a second area defined by(n*d)*(m*d), and an amount of information encoded by the encoder is greater than (n*d)*(m*d) as measured in bits.

Clause 48. The optical tag circuit of clause 47, wherein one or more outer edges of the optical tag circuit is less than 3 millimeters.

Clause 49. The optical tag circuit of any of clauses 47-48, wherein the light emitter comprises one of a vertical-cavity surface-emitting laser (VCSEL), a micro light-emitting diode (microLED), and a resonant-cavity light-emitting diode (RCLED).

Clause 50. The optical tag circuit of any of clauses 47-49, wherein the incident light comprises a broad spectrum of wavelengths from one or more of ambient light, reflected light, sunlight, light reflected from the optical tag circuit, and light from a mobile device.

Clause 51. The optical tag circuit of any of clauses 47-50, wherein the optical tag circuit further comprises a clock generation circuit configured to provide a steady bit rate to provide the information.

Clause 52. The optical tag circuit of any of clauses 47-51, wherein the power source is further configured to accumulate electric energy transduced from the incident light and release the accumulated electric energy as a pulse configured to drive the light emitter.

Clause 53. The optical tag circuit of clause 52, wherein the power source is configured to provide the pulse for a pulse duration, the pulse duration being approximately 10000 times less than a bit period to provide the information.

Clause 54. The optical tag circuit of clause 53, wherein a number of photons emitted by the light emitter during the bit period is greater than one percent of the photons in the incident light during the bit period.

Clause 55. The optical tag circuit of clause 52, wherein the light emitter comprises a vertical-cavity surface-emitting laser (VCSEL).

Clause 56. The optical tag circuit of clause 55, wherein the VCSEL is configured to emit light in a conical emission profile.

Clause 57. The optical tag circuit of clause 55, wherein the VCSEL is configured to emit light in a scattered pattern.

Clause 58. The optical tag circuit of clause 55, wherein the VCSEL is configured to emit light in a wide emission area.

Clause 59. The optical tag circuit of clause 52, wherein the optical tag circuit comprises:
an integrated circuit comprising an encoder configured to generate the encoded optical signal and a pulse generator configured to trigger the pulse; and
a plurality of semiconductor optoelectronics configured to transduce the incident light to electric energy.

Clause 60. The optical tag circuit of clause 59, wherein the optical tag circuit is further configured to receive data from one or more sensors associated with an object and store the data as the information in a memory configured to be read by the encoder.

Clause 61. The optical tag circuit of any of clauses 47-60, wherein the power source is further configured to provide the electric current while receiving less than 10 microwatts per square millimeter of incident light.

Clause 62. The optical tag circuit of any of clauses 47-61, wherein the optical signal comprises a binary encoding such that a 1 corresponds to a state where light is emitted by the light emitter and 0 corresponds to the state where there is no light emission by the light emitter, and 0s occur in groups of 2*N, wherein N is an integer.

Clause 63. The optical tag circuit of clause 62, wherein the optical signal further comprises a finite integer limit for a number of zeros repeated in a sequence.

Clause 64. The optical tag circuit of any of clauses 47-63, wherein an area of the optical tag circuit measured as a first dimension X times a second dimension Y is less than 9 square millimeters.

Clause 65. The optical tag circuit of any of clauses 47-64, wherein a first optical tag circuit comprising a first dimension X and a second optical tag circuit comprising second dimension Y oriented such that the first optical tag circuit is adjacent to the second optical tag circuit and a combination of the first optical tag circuit and the second optical tag circuit comprises a combined dimension X+Y that is less than a minimum dimension related to a unit pixel resolution of the image capture device.

Clause 66. The optical tag circuit of any of clauses 47-65, wherein the light emitter is configured to emit light when the incident light comprises an intensity less than 10 milliwatts per square millimeter.

Clause 67. The optical tag circuit of any of clauses 47-66, wherein the optical tag circuit further comprises a configuration memory storing one or more of predefined brightness information and predefined emission frequency of the light emitter.

Clause 68. An optical tag circuit for providing information via an optical signal, comprising:
a power source configured to transduce incident light to an electric current for powering the optical tag circuit;
a light emitter configured to emit an optical signal in response to an electrical pulse;
an encoder configured to encode the information and provide the encoded information as an electrical pulse to the light emitter;
wherein the encoder is configured to broadcast the optical signal via the light emitter without reception of external frequency data prior to the broadcast based on a predetermined current threshold of the power source.

Clause 69. The optical tag circuit of clause 68, comprising an anti-reflective layer applied on at least a surface of the optical tag circuit exposed to the ambient light, wherein the anti-reflective layer comprises a void at a region of the optical tag circuit where the light emitter is located.

Clause 70. The optical tag circuit of clause 69, wherein the power source comprises a plurality of photovoltaic elements, and wherein the optical tag circuit comprises an absorption layer configured to increase absorption of the ambient light into the plurality of photovoltaic elements, the absorption layer comprising a second void in a region of the optical tag circuit where the light emitter is located.

Clause 71. The optical tag circuit of clause 70, wherein the optical signal is comprised of a wavelength of light, and the anti-reflective layer is configured to increase absorption of the ambient light by the plurality of photovoltaic elements, the anti-reflective layer exhibiting optical transparency at the wavelength.

Clause 71a. The optical tag circuit of any of clauses 69-71, wherein the anti-reflective layer is applied to one or more interconnects exposed on the surface the optical tag circuit.

Clause 72. The optical tag circuit of any of clauses 68-71, wherein the optical signal comprises at least one wavelength of light, including at least one wavelength that overlaps with at least one wavelength of the incident light.

Clause 73. The optical tag circuit of any of clauses 68-72, wherein the information comprises a unique identifier linked to digital content in a cloud database.

Clause 74. The optical tag circuit of any of clauses 68-73, wherein the optical tag circuit is configured to receive data from one or more sensors associated with an object and store the data as the information in a memory configured to be read by the encoder.

Clause 75. The optical tag circuit of any of clauses 68-74, wherein the optical tag circuit is configured to automatically vary an intensity of the optical signal based on an intensity of incident light.

Clause 76. The optical tag circuit of any of clauses 68-75, wherein the encoder is further configured to encode the information in a series of consecutive sets of electrical pulses, each set of electrical pulses being comprised of a plurality of electrical pulses.

Clause 77. The optical tag circuit of any of clauses 68-76, wherein the power source comprises a first plurality of photovoltaic cells connected in series and configured to operate at a first voltage to provide electric current to the light emitter during the electrical pulse, and a second plurality of photovoltaic cells connected in parallel and configured to operate at a second voltage lower than the first voltage to provide electric current to the encoder.

Clause 78. The optical tag circuit of any of clauses 68-77, wherein the encoder is further configured to encode the information using a bit map corresponding to a variable pulse frequency associated with a plurality of the electrical pulses.

Clause 79. The optical tag circuit of any of clauses 68-78, wherein the incident light comprises a broad spectrum of wavelengths of one or more of ambient light, reflected light, sunlight, light reflected from the optical tag circuit, and light from a mobile device.

Clause 80. The optical tag circuit of any of clauses 68-79, wherein the optical tag circuit further comprises a clock generation circuit configured to provide a steady bit rate to provide the information.

Clause 81. The optical tag circuit of any of clauses 68-80, wherein the power source is further configured to accumulate electric energy transduced from the incident light and release the accumulated electric energy as an electrical pulse configured to drive the light emitter.

Clause 82. The optical tag circuit of clause 81, wherein the light emitter comprises a vertical-cavity surface-emitting laser (VCSEL).

Clause 83. The optical tag circuit of clause 82, wherein the VCSEL is configured to emit light in a conical emission profile.

Clause 84. The optical tag circuit of clause 82, wherein the VCSEL is configured to emit light in a scattered pattern.

Clause 85. The optical tag circuit of clause 82, wherein the VCSEL is configured to emit light in a wide emission area.

Clause 86. The optical tag circuit of clause 81, wherein the optical tag circuit comprises:
an integrated circuit comprising an encoder configured to generate the encoded optical signal and a pulse generator configured to trigger the electrical pulse; and
a plurality of semiconductor optoelectronics configured to transduce the incident light to electric current.

Clause 87. The optical tag circuit of any of clauses 68-86, wherein the optical tag circuit is further configured to receive data from one or more sensors associated with an object and store the data as the information in a memory configured to be read by the encoder.

Clause 88. The optical tag circuit of any of clauses 68-87, wherein the power source is configured to provide the electrical pulse for a pulse duration, the pulse duration being approximately 10000 times less than a bit period to provide the information.

Clause 89. The optical tag circuit of clause 88, wherein a number of photons emitted by the light emitter during the bit period is greater than 1% of the photons in the incident light during the bit period.

Clause 90. The optical tag circuit of any of clauses 68-89, wherein the power source is further configured to provide the electric current while receiving less than 10 microwatts per square millimeter of incident light.

Clause 91. The optical tag circuit of any of clauses 68-90, wherein the encoded optical signal comprises a binary encoding such that a 1 corresponds to a state where light is emitted by the light emitter and 0 corresponds to the state where there is no light emission by the light emitter, and 0s occur in groups of 2*N, wherein N is an integer.

Clause 92. The optical tag circuit of clause 91, wherein the encoded optical signal further comprises a finite integer limit for a number of zeros repeated in a sequence.

Clause 93. The optical tag circuit of any of clauses 68-92, wherein an area of the optical tag circuit measured as a first dimension X times a second dimension Y is less than 9 square millimeters.

Clause 94. The optical tag circuit of any of clauses 68-93, wherein a first optical tag circuit comprising a first dimension X and a second optical tag circuit comprising second dimension Y oriented such that the first optical tag circuit is adjacent to the second optical tag circuit and a combination of the first optical tag circuit and the second optical tag circuit comprises a combined dimension X+Y that is less than a minimum dimension related to a unit pixel resolution of the image capture device.

Clause 95. The optical tag circuit of any of clauses 68-94, wherein the light emitter is configured to emit light when the incident light comprises an intensity less than 10 milliwatts per square millimeter.

Clause 96. The optical tag circuit of any of clauses 68-95, wherein the optical tag circuit further comprises a configuration memory storing one or more of predefined brightness information and predefined emission frequency of the light emitter.

Clause 97. An optical tag circuit reader configured to determine information via an optical signal, comprising:
an image capture device configured to capture an encoded optical signal broadcast from an optical tag circuit without transmitting frequency data to the optical tag circuit prior to the capture of the encoded optical signal; and
a processor configured to:
   determine a decoding scheme based on the encoded optical signal; and
decode the encoded optical signal based on the decoding scheme to obtain the information.

Clause 98. The optical tag circuit reader of clause 97, wherein no downlink from the optical tag circuit reader to the optical tag circuit.

Clause 99. The optical tag circuit reader of any of clauses 97-98, wherein the decoding scheme is determined without handshaking with the optical tag circuit.

Clause 100. The optical tag circuit reader of any of clauses 97-99, wherein the image capture device comprises a camera mounted in a mobile device.

Clause 101. The optical tag circuit reader of clause 100, wherein the mobile device comprises a smartphone.

Clause 102. The optical tag circuit reader of any of clauses 97-101, wherein the image capture device is further configured to capture one or more images of an object on which the optical tag circuit is mounted, and wherein the processor is configured to identify visual characteristics of the object and compare the visual characteristics to the information.

Clause 103. The optical tag circuit reader of any of clauses 97-102, wherein the decoding scheme is further configured to translate information from a ratio of a variable frequency of pulses corresponding to the optical signal to a frame rate frequency of the image capture device.

Clause 104. The optical tag circuit reader of clause 103, wherein the decoding scheme is further configured to handle one or more errors associated with collection of the optical signal by the image capture device to facilitate transmission of the information.

Clause 105. The optical tag circuit reader of clause 104, wherein the one or more errors relate to a read noise during an analog-to-digital conversion of the optical signal.

Clause 106. The optical tag circuit reader of any of clauses 97-105, wherein the processor is further configured to decode the information in the optical signal using a bit map corresponding to a variable pulse frequency associated with a plurality of pulses of the optical signal.

Clause 107. The optical tag circuit reader of any of clauses 97-106, wherein the processor is further configured to decode the optical signal using a decoding scheme to translate information from a ratio of a variable frequency of pulses corresponding to the optical signal to a frame rate frequency of the image capture device.

Clause 108. The optical tag circuit reader of clause 107, wherein the decoding scheme is further configured to handle one or more errors associated with collection of the encoded optical signal by the image capture device to facilitate transmission of the information.

Clause 109. The optical tag circuit reader of clause 108, wherein at least one of the one or more errors is caused by a deadzone of the image capture device.

Clause 110. The optical tag circuit reader of clause 109, wherein the deadzone occurs for a deadzone duration greater than one percent of a capture period corresponding to the capture frequency.

Clause 111. The optical tag circuit reader of any of clauses 97-110, wherein the processor is further configured to decode the optical signal using a decoding scheme to provide the information for a plurality of ratios of the emission frequency to the capture frequency.

Clause 112. The optical tag circuit reader of any of clauses 97-111, wherein the image capture device is configured to capture the encoded optical signal with a spatial resolution limited by a diffraction limit.

Clause 113. The optical tag circuit reader of any of clauses 97-112, wherein the image capture device is configured to capture the encoded optical signal for a wavelength of light, λ, a distance from the optical tag circuit to a lens of the image capture device, y, and a diameter of an aperture of the image capture device, D, and a diffraction constant, C, with a spatial resolution limited by C*λ*(y/D).

Clause 114. The optical tag circuit reader of any of clauses 97-113, wherein the image capture device is configured to capture the encoded optical signal at a spatial resolution limited by the diameter of an Airy Disc of an aperture of the image capture device.

Clause 115. A system configured to provide information via an optical signal, comprising:
an optical tag circuit comprising:
an electric power source configured to generate an electric current for powering the optical tag circuit from incident light; and
a light emitter configured to emit the information as an encoded optical signal;
an optical tag circuit reader comprising:
an image capture device having a fixed unit pixel resolution, wherein one or more outer dimensions of the optical tag circuit are smaller than the fixed unit pixel resolution; and
a processor configured to determine the information from the encoded optical signal.

Clause 116. The system of clause 115, wherein no handshake occurs between the optical tag circuit reader and the optical tag circuit prior to and during capture of the encoded optical signal.

Clause 117. The system of any of clauses 115-116, wherein the optical tag circuit reader is a mobile device and the image capture device is comprised by a camera mounted on the mobile device.

Clause 118. The system of clause 117, wherein the mobile device comprises a smartphone.

Clause 119. The system of any of clauses 115-118, wherein the light emitter comprises one of a vertical-cavity surface-emitting laser (VCSEL), a micro light-emitting diode (microLED), and a resonant-cavity light-emitting diode (RCLED).

Clause 120. The system of any of clauses 115-119, wherein the incident light comprises one or more of ambient light, reflected light, sunlight, light reflected from the optical tag circuit, and light from a mobile device.

Clause 121. The system of any of clauses 115-120, wherein the optical tag circuit reader is further configured to compare pixel data for a location incident with the encoded optical signal to pixel data from pixels adjacent to the location.

Clause 122. The system of any of clauses 115-121, wherein the optical tag circuit is further configured to generate a plurality of pulses to cause the light emitter to emit light in an information transmission period, wherein a first duration between each pulse of the plurality of pulses within an information period is greater than a second duration corresponding to a readout time of the image capture device and less than half of the information transmission period.

Clause 123. The system of any of clauses 115-122, wherein at least some of the incident light originates from the optical tag circuit reader.

Clause 124. The system of any of clauses 115-123, wherein the optical tag circuit is further configured to increase a brightness of light from the light emitter over a plurality of orders of magnitude of an intensity of the incident light such that the optical tag circuit reader is able to determine the information.

Clause 125. The system of any of clauses 115-124, wherein the processor is further configured to decode the optical signal using a decoding scheme to translate information from a ratio of the variable frequency of pulses corresponding to the optical signal to a frame rate frequency of the image capture device.

Clause 126. The system of clause 125, wherein the decoding scheme is further configured to handle one or more errors associated with collection of the encoded optical signal by the image capture device to facilitate transmission of the information.

Clause 127. The system of clause 126, wherein at least one of the one or more errors is caused by a deadzone of the image capture device.

Clause 128. The system of clause 127, wherein the deadzone occurs for a deadzone duration greater than 1% of a capture period corresponding to the image capture frequency.

Clause 129. The system of any of clauses 115-128, wherein the image capture device is configured to capture the encoded optical signal with a spatial resolution limited by a diffraction limit.

Clause 130. The system of any of clauses 115-129, wherein the image capture device is configured to capture the encoded optical signal for a wavelength of light, λ, a distance from the optical tag circuit to a lens of the image capture device, y, and a diameter of an aperture of the image capture device, D, and a diffraction constant, C, with a spatial resolution limited by C*λ*(y/D).

Clause 131. The system of any of clauses 115-130, wherein the image capture device is configured to capture the encoded optical signal at a spatial resolution limited by the diameter of an Airy Disc of an aperture of the image capture device.

Clause 132. The system of any of clauses 115-131, wherein the optical tag circuit further comprises a clock generation circuit configured to provide a steady bit rate to provide the information.

Clause 133. The system of any of clauses 115-132, wherein the electric power source is further configured to accumulate electric energy transduced from the incident light and release the accumulated electric energy as a pulse configured to drive the light emitter.

Clause 134. The system of any of clauses 115-133, wherein the electric power source is configured to provide the pulse for a pulse duration, the pulse duration being approximately 10000 times less than a bit period to provide the information.

Clause 135. The system of clause 134, wherein a number of photons emitted by the light emitter during the bit period is greater than one percent of the photons in the incident light during the bit period.

Clause 136. The system of any of clauses 115-135, wherein the light emitter comprises a vertical-cavity surface-emitting laser (VCSEL).

Clause 137. The system of clause 136, wherein the VCSEL is configured to emit light in a conical emission profile.

Clause 138. The system of clause 136, wherein the VCSEL is configured to emit light in a scattered pattern.

Clause 139. The system of clause 136, wherein the VCSEL is configured to emit light in a wide emission area.

Clause 140. The system of any of clauses 115-139, wherein the electric power source is further configured to provide the electric current while receiving less than 10 microwatts per square millimeter of incident light.

Clause 141. The system of any of clauses 115-140, wherein the optical tag circuit comprises:
an integrated circuit comprising an encoder configured to generate the encoded optical signal and a pulse generator configured to trigger the pulse; and
a plurality of semiconductor optoelectronics configured to transduce the incident light to electric energy.

Clause 142. The system of clause 141, wherein the optical tag circuit is further configured to receive data from one or more sensors associated with an object and store the data as the information in a memory configured to be read by the encoder.

Clause 143. The system of any of clauses 115-142, wherein the encoded optical signal comprises a binary encoding such that a 1 corresponds to a state where light is emitted by the light emitter and 0 corresponds to the state where there is no light emission by the light emitter, and 0s occur in groups of 2*N, wherein N is an integer.

Clause 144. The system of clause 143, wherein the encoded optical signal further comprises a finite integer limit for a number of zeros repeated in a sequence.

Clause 145. The system of any of clauses 115-144, wherein an area of the optical tag circuit measured as a first dimension X times a second dimension Y is less than 9 square millimeters.

Clause 146. The system of any of clauses 115-145, wherein a first optical tag circuit comprising a first dimension X and a second optical tag circuit comprising second dimension Y oriented such that the first optical tag circuit is adjacent to the second optical tag circuit and a combination of the first optical tag circuit and the second optical tag circuit comprises a combined dimension X+Y that is less than a minimum dimension related to a unit pixel resolution of the image capture device

Clause 147. The system of any of clauses 115-146, wherein the light emitter is configured to emit light when the incident light comprises an intensity less than 10 milliwatts per square millimeter.

Clause 148. The system of any of clauses 115-147, wherein the optical tag circuit further comprises a configuration memory storing one or more of predefined brightness information and predefined emission frequency of the light emitter.

Clause 149. The system of any of clauses 115-148, wherein no downlink from the optical tag circuit reader to the optical tag circuit.

Clause 150. The system of any of clauses 115-149, wherein the decoding scheme is determined without handshaking with the optical tag circuit.

Clause 151. The system of any of clauses 115-150, wherein the image capture device comprises a camera mounted in a mobile device.

Clause 152. The system of clause 151, wherein the mobile device comprises a smartphone.

Clause 153. The system of any of clauses 115-152, wherein the image capture device is further configured to capture one or more images of an object on which the optical tag circuit is mounted, and wherein the processor is configured to identify visual characteristics of the object and compare the visual characteristics to the information.

Clause 154. The system of any of clauses 115-153, wherein determining the information occurs with a decoding scheme configured to translate information from a ratio of a variable frequency of pulses corresponding to the optical signal to a frame rate frequency of the image capture device.

Clause 155. The system of clause 154, wherein the decoding scheme is further configured to handle one or more errors associated with collection of the optical signal by the image capture device to facilitate transmission of the information.

Clause 156. The system of clause 155, wherein the one or more errors relate to a read noise during an analog-to-digital conversion of the optical signal.

Clause 157. The system of any of clauses 115-156, wherein the processor is further configured to determine the information in the optical signal using a bit map corresponding to a variable pulse frequency associated with a plurality of pulses of the optical signal.

Clause 158. The system of any of clauses 115-157, wherein the processor is further configured to determine the information from the optical signal using the decoding scheme to translate information from a ratio of a variable frequency of pulses corresponding to the optical signal to a frame rate frequency of the image capture device.

Clause 159. The system of clause 158, wherein the decoding scheme is further configured to handle one or more errors associated with collection of the encoded optical signal by the image capture device to facilitate transmission of the information.

Clause 160. The system of clause 159, wherein at least one of the one or more errors is caused by a deadzone of the image capture device.

Clause 161. The system of clause 160, wherein the deadzone occurs for a deadzone duration greater than 1% of a capture period corresponding to the frame rate frequency.

Clause 162. The system of clause 158, wherein the processor is further configured to decode the optical signal using a decoding scheme to provide the information for a plurality of ratios of an emission frequency of the light emitter to the frame rate frequency.

Clause 163. The system of any of clauses 115-162, wherein the image capture device is configured to capture the encoded optical signal with a spatial resolution limited by a diffraction limit.

Clause 164. The system of any of clauses 115-163, wherein the image capture device is configured to capture the encoded optical signal for a wavelength of light, λ, a distance from the optical tag circuit to a lens of the image capture device, y, and a diameter of an aperture of the image capture device, D, and a diffraction constant, C, with a spatial resolution limited by C*λ*(y/D).

Clause 165. The system of any of clauses 115-164, wherein the image capture device is configured to capture the encoded optical signal at a spatial resolution limited by the diameter of an Airy Disc of an aperture of the image capture device.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It is appreciated that the above-described embodiments can be implemented by hardware, software (program codes), or a combination of hardware and software. If implemented by software, it can be stored in computer-readable media of the associated device (e.g., a memory of the optical tag reader 104). The software, when executed by the processor can perform the disclosed methods. The computing units and other functional units described in the present disclosure can be implemented by hardware, software, or a combination of hardware and software. One of ordinary skill in the art will also understand that multiple ones of the above-described modules/units can be combined as one module or unit, and each of the above-described modules/units can be further divided into a plurality of sub-modules or sub-units.

For example, program sections or program modules can be designed in or by means of . Net Framework, . Net Compact Framework (and related languages, such as Visual Basic, C, etc.), Java, C++, Objective-C, HTML, HTML/AJAX combinations, XML, or HTML with included Java applets. The various programs or program modules can be created using a variety of programming techniques. One or more of such software sections or modules can be integrated into a computer system, non-transitory computer readable media, or existing software. Computer programs based on the written description and methods of this specification are within the skill of a software developer.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. Although certain features of the present disclosure are described under various headings of the text, this is not intended to delineate separate embodiments, but instead to assist the reader. In other words, the various sections of the text are intended to be utilized by those skilled in the art in various combinations for implementing embodiments of the present disclosure.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Various terms used in the specification and claims may be defined or summarized differently when discussed in connection with differing disclosed embodiments. It is to be understood that the definitions, summaries and explanations of terminology in each instance apply to all instances, even when not repeated, unless the transitive definition, explanation or summary would result in inoperability of an embodiment.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

What is claimed is:

1. A system configured to provide information via an optical signal, the system comprising:
an optical tag circuit comprising:
an electric power source configured to generate an electric current for powering the optical tag circuit from incident light; and
a light emitter configured to emit the information as an encoded optical signal at an emission frequency; and
an optical tag circuit reader comprising:
an image capture device configured to capture the encoded optical signal at a capture frequency without requiring synchronization of the capture frequency to the emission frequency; and
a processor configured to obtain the information from the encoded optical signal.

2. The system of claim 1 wherein the capture frequency is different from the emission frequency.

3. The system of claim 1 wherein the optical tag circuit is configured to operate with no downlink from the optical tag circuit reader.

4. The system of claim 1 wherein the incident light comprises a broad spectrum of wavelengths from one or more of ambient light, reflected light, sunlight, light reflected from the optical tag circuit, or light from a mobile device.

5. The system of claim 4 wherein the mobile device comprises at least one processor configured to use one or more of image stabilization or tracking to track the encoded optical signal.

6. The system of claim 1 wherein the optical tag circuit reader is a mobile device and the image capture device comprises a camera mounted on the mobile device.

7. The system of claim 1 wherein the electric power source comprises at least one photovoltaic cell.

8. The system of claim 1 wherein the electric power source comprises:
a first photovoltaic cell stack configured to provide a first voltage to the optical tag circuit; and
a second photovoltaic cell stack configured to provide a second voltage, higher than the first voltage, to the light emitter.

9. The system of claim 8 wherein the electric power source further comprises at least one power storage device configured to store electric power provided by one of the first photovoltaic cell stack or the second photovoltaic cell stack.

10. The system of claim 1 wherein the image capture device is further configured to capture one or more images of an object on which the optical tag circuit is mounted, and wherein the processor is configured to identify visual characteristics of the object.

11. The system of claim 1 wherein the optical tag circuit comprises an integrated circuit configured to encode the information and provide timing and power pulses.

12. The system of claim 1 wherein the optical tag circuit further comprises a clock generation circuit configured to provide a steady bit rate to provide the information.

13. The system of claim 1 wherein the electric power source is further configured to accumulate electric energy transduced from the incident light and release the accumulated electric energy as a pulse configured to drive the light emitter.

14. The system of claim 13 wherein the optical tag circuit comprises:
an integrated circuit comprising an encoder configured to generate the encoded optical signal and a pulse generator configured to trigger the pulse; and
a plurality of semiconductor optoelectronics configured to transduce the incident light to electric energy.

15. The system of claim 1 wherein the light emitter comprises a vertical-cavity surface-emitting laser (VCSEL).

16. The system of claim 1 wherein a first optical tag circuit comprising a first dimension X and a second optical tag circuit comprising second dimension Y oriented such that the first optical tag circuit is adjacent to the second optical tag circuit and a combination of the first optical tag circuit and the second optical tag circuit comprises a combined dimension X +Y that is less than a minimum dimension related to a unit pixel resolution of the image capture device, the first and second optical tag circuits are not resolvable as two distinct optical tag circuits from a distance of 1 meter.

17. The system of claim 1 wherein the optical tag circuit is further configured to generate a plurality of pulses to cause the light emitter to emit light in an information transmission period, wherein a first duration between each pulse of the plurality of pulses within an information period is greater than a second duration corresponding to a readout time of the image capture device and less than half of the information transmission period.

18. The system of claim 1 wherein the processor is further configured to decode the optical signal using a decoding scheme to provide the information for a plurality of ratios of the emission frequency to the capture frequency.

19. The system of claim 1 wherein the image capture device is configured to capture the encoded optical signal for a wavelength of light, λ, a distance from the optical tag circuit to a lens of the image capture device, y, and a diameter of an aperture of the image capture device, D, and a diffraction constant, C, with a spatial resolution limited by C*λ*(y/D).

20. The system of claim 1 wherein the image capture device is configured to capture the encoded optical signal at a spatial resolution limited by the diameter of an Airy Disc of an aperture of the image capture device.
